(19) United States
(12) Patent Application Publication
(10) Pub. No.: US 2014/0265617 A1
(43) Pub. Date: Sep. 18, 2014

(54) WIRELESS ENERGY TRANSFER

(71) Applicant: WiTricity Corporation, Watertown, MA (US)

(72) Inventors: Arunanshu Mohan Roy, Cambridge, MA (US); Volkan Efe, Watertown, MA (US); Aristeidis Karalis, Boston, MA (US); Andre B. Kurs, Chestnut Hill, MA (US); Alexander Patrick McCauley, Cambridge, MA (US); Morris P. Kesler, Bedford, MA (US); Katherine L. Hall, Arlington, MA (US)

(21) Appl. No.: 14/199,083

(22) Filed: Mar. 6, 2014

Related U.S. Application Data
(60) Provisional application No. 61/790,964, filed on Mar. 15, 2013.

(51) Int. Cl. H01F 38/14

(52) U.S. Cl. CPC H01F 38/14
USPC 307/104

(57) ABSTRACT

A wireless power system includes: i) a power source; ii) a source resonator configured to receive power from the power source; iii) a receiver resonator configured to provide power to a load; and iv) at least one repeater resonator configured to couple power wirelessly from the source resonator to the receiver resonator. The power source is configured to provide power to the source resonator at a first frequency f₁ different from at least one of the resonant frequencies corresponding to the resonators.

### CROSS-REFERENCE TO RELATED APPLICATION

Pursuant to 35 U.S.C. §119, this application claims the benefit of U.S. Provisional Application Ser. No. 61/790,964, filed on Mar. 15, 2013, whose disclosure content is hereby incorporated by reference in its entirety.

### TECHNICAL FIELD

This specification relates to wireless energy transfer techniques.

### BACKGROUND

Energy can be transferred from a power source to receiving device (e.g., an electronic device) using a variety of known techniques such as radiative (far-field) techniques. For example, radiative techniques using low-directionality antennas can transfer a small portion of the supplied radiated power, namely, that portion in the direction of, and overlapping with, the receiving device used for pick up. In this example, most of the energy is radiated away in all the other directions than the direction of the receiving device, and typically the transferred energy is insufficient to power or charge the receiving device. In another example of radiative techniques, directional antennas are used to confine and preferentially direct the radiated energy towards the receiving device. In this case, an uninterruptible line-of-sight and potentially complicated tracking and steering mechanisms are used.

Another approach is to use non-radiative (near-field) techniques. For example, techniques known as traditional induction schemes do not (intentionally) radiate power, but uses an oscillating current passing through a primary coil, to generate an oscillating magnetic near-field that induces currents in a near-by receiving or secondary coil. Traditional induction schemes can transfer modest to large amounts of power over very short distances. In these schemes, the offset tolerances between the power source and the receiving device are very small. Electric transformers and proximity chargers are examples using the traditional induction schemes.

### SUMMARY

In general, in one aspect, a wireless power system is disclosed. The system includes: i) a power source; ii) a source resonator configured to receive power from the power source; iii) a receiver resonator configured to provide power to a load; and iv) at least one repeater resonator configured to couple power wirelessly from the source resonator to the receiver resonator. The power source is configured to provide power to the source resonator at a first frequency f₁ different from at least one of the resonant frequencies corresponding to the resonators.

In general, in another aspect, a wireless power method is disclosed. The method includes: i) providing power from a power source to a source resonator; ii) wirelessly transferring power from the source resonator to a receiver resonator through at least one repeater resonator; and iii) providing power from the receiver resonator to a load. The power source provides power to the source resonator at a first frequency f₁ different from at least one of the resonant frequencies corresponding to the resonators.

In general, in a further aspect, a method of operating a wireless power system is disclosed. The method includes: i) providing energy from a power source to a source resonator at an operating frequency fₒ; ii) wirelessly transferring energy from the source resonator to one or more receiving resonators through at least one repeater resonator at the operating frequency fₒ; and iii) adjusting the operating frequency fₒ to include at least a first frequency f₁ different from at least one of the resonant frequencies corresponding to the resonators to control the energy transfer distribution to the one or more receiving resonators.

In general, in a further aspect, a method for configuring a wireless power system is disclosed. The method includes: i) providing energy from a power source to a source resonator; ii) wirelessly transferring energy from the source resonator to one or more receiving resonators through at least one repeater resonator at an operating frequency fₒ; and iii) adjusting the operating frequency fₒ to include at least a first frequency f₁ different from a resonant frequency fₛ of the source resonator.

In general, in a further aspect, another method for configuring a wireless power system is disclosed. The method includes: i) providing a power source to provide power to a source resonator at an operating frequency fₒ; ii) positioning one or more receiver resonators, each coupled to a load, at respective desired positions; iii) positioning at least one repeater resonator to wirelessly transfer energy from the source resonator to one or more receiving resonators through the at least one repeater resonator; and iv) adjusting the operating frequency fₒ and/or the position of at least one of the repeater resonators to improve the wireless energy transfer to the one or more receiver resonators, wherein the operating frequency fₒ is adjusted to include at least a first frequency f₁ different from at least one of the resonant frequencies corresponding to the resonators.

Embodiments of any of the system and methods described above can include any of the following features.

The source resonator can have a resonant frequency fₛ=ωₛ/2π, an intrinsic loss rate Γₛ, and can be capable of storing electromagnetic energy with an intrinsic quality factor Qₛ=ωₛ/(2Γₛ). The receiver resonator can have a resonant frequency f_{rc}=ω_{rc}/2π, an intrinsic loss rate Γ_{rc} and can be capable of storing electromagnetic energy with an intrinsic quality factor Q_{rc}=ω_{rc}/(2Γ_{rc}). The first repeater resonator can have a resonant frequency fᵣ₁=ωᵣ₁/2π, an intrinsic loss rate Γᵣ₁, and can be capable of storing electromagnetic energy with an intrinsic quality factor Qᵣ₁=ωᵣ₁/(2Γᵣ₁).

In certain embodiments, the first frequency f₁ can differ from at least one of the resonant frequencies by more than 3%, or by more than 5%. Furthermore, for example, the first frequency f₁ can differ from each of the resonant frequencies by more than 3%, or by more than 5%.

In certain embodiments, the at least one repeater resonator can include multiple repeater resonators configured to couple power wirelessly from the source resonator to the receiver resonator.

In certain embodiments, the resonators are spatially distributed, and the spatial distribution of the resonators causes the receiving resonator to receive power from the source resonator through the at least one repeater resonator with an energy transfer efficiency 111 larger than 30% and wherein η1 varies by less than 5% when f₁ varies by less than 5%.

In certain embodiments, the resonators are spatially distributed, and the spatial distribution of the resonators causes the receiving resonator to receive power from the source resonator through the at least one repeater resonator with an energy transfer efficiency η₁, when the power source provides power to the source resonator at a frequency that differs from at least one of the resonant frequencies by more than 3%, and with an energy efficiency ηo<η1, when the power source provides power to the source resonator at a frequency that does not differ from the at least one of the resonant frequencies by more than 3%. Furthermore, for example, in certain embodiments, the resonators are spatially distributed, and the spatial distribution of the resonators causes the receiving resonator to receive power from the source resonator through the at least one repeater resonator with an energy transfer efficiency η₁, when the power source provides power to the source resonator at a frequency that differs from each of the resonant frequencies by more than 3%, and with an energy efficiency ηo<η1, when the power source provides power to the source resonator at a frequency that does not differ from each of the resonant frequencies by more than 3%.

In certain embodiments, during operation, the power source is configured to vary the frequency of the power provided to the source resonator. For example, the power source can be configured to adjust the frequency of the power provided to the source resonator to at least one other frequency f₀ within a range of frequencies including the first frequency f₁. In certain implementations, for example, the power source is configured to adjust the frequency of the power source continuously within the range of frequencies. In other implementations, for example, the power source is configured to adjust the frequency of the power source to select among multiple discrete frequencies including f₁ and f₀.

For example, the frequency f₀ can be equal to the resonant frequency of at least one of the resonators and/or the frequency f₀ can differ from the resonant frequency of at least one of the resonators by at least 5%. Furthermore, in certain embodiments, the power source is configured to vary the frequency of the power provided to the source resonator as at least one of the resonators moves relative to another one of the resonators.

In certain embodiment, the power source is configured to provide power to the source resonator at each of the first frequency f₁ and at least one other frequency f₀ within a range of frequencies including the first frequency f₁. In certain implementations, the power source is configured to provide power to the source resonator at the frequencies f₁ and f₀ at the same time. For example, the frequency f0 can be equal to the resonant frequency of at least one of the resonators and/or the frequency f0 can differ from the resonant frequency of at least one of the resonators by at least 5%.

In certain embodiments, at least one of the intrinsic quality factors is greater than 100. Furthermore, in certain cases, at least two of the intrinsic quality factors are greater than 100. For example, in certain cases, each of the source resonator, the receiver resonator, and at least one of the repeater resonators has an intrinsic quality factor greater than 100.

In certain embodiments, at least one of the resonators includes a capacitively loaded conducting wire loop.

In certain embodiments, the characteristic size L_{rc} of the receiver resonator is smaller than the characteristic size of the at least one repeater resonator Lᵣ₁.

In certain embodiments, the first frequency f₁ differs from the resonant frequency of the at least one resonator by an amount greater than the intrinsic loss rate for the at least one resonator. For example, in certain embodiments, the first frequency f₁ differs from the resonant frequency of each of at least some of the resonator by an amount greater than the intrinsic loss rate for each of the respective resonators.

In certain embodiments, the wireless power system includes multiple receiver resonators each coupled to a load and configured to receive power wirelessly from the source resonator through the at least one repeater resonator.

The load can be, for example, any of a light, a battery, a robot, a cell phone, a tablet computer, a lap top computer, a monitor, a television, or any other consumer electronic device.

In certain embodiments, at least some of the resonators are distributed among cabinets to provide wireless power to under-cabinet applications, such as lighting.

In certain embodiments, at least some of the resonators are distributed among floor tiles to provide wireless power to one or more loads supported above the floor tiles.

In certain embodiments, the methods can further include measuring a property of the wireless energy transfer as the operating frequency is adjusted to determine an operating frequency fₒ that improves the wireless energy transfer relative to that for an operating frequency fₒ equal to the resonant frequency fₛ for the source resonator. The measured property of the wireless energy transfer can be, for example, any of: an energy output from the source resonator; an energy input to the one or more receiving resonators; an efficiency of the wireless energy transfer to the one or more receiving resonators; and an impedance spectrum for each of one or more of the resonators.

Furthermore, in certain embodiments, the methods can further include adjusting a position of one or more of the resonators. For example, the position of at least one of the receiving resonators is adjusted, and/or the position of at least one of the repeaters resonators is adjusted.

In certain embodiments, the methods can further include measuring a property of the wireless energy transfer as a function of the adjusted operating frequency and the adjusted position of the one or more repeater resonators.

In certain embodiments, the methods further including measuring a property of the wireless energy transfer as a function of the adjustment to the operating frequency and/or position of the at least one repeater resonator. The operating frequency fₒ and the position of at least one of the repeater resonators can then be adjusted to improve the wireless energy transfer to the one or more receiver resonators.

The techniques disclosed in this specification provide numerous benefits and advantages (some of which may be achieved only in some of the various aspect and implementations) including the following. The disclosed techniques can be used to transfer energy in useful amounts of electrical power over mid-range distances without the need of uninterruptible line-of-sight or complicated tracking and steering mechanisms. The tolerance for alignment offsets between a source and a receiver can be high. For example, energy transfer can be efficient while the receiver is in motion. In addition, humans may not be exposed to hazards from exposure of magnetic fields involved in the energy transfer.

In general, the disclosed techniques can be used to extend the range of wireless energy transfer. For example, the energy can be extended using one or more repeater resonators. Further, the energy transfer range, efficiency, and/or distribution can be controlled by adjusting the operating frequency of a power source, resonant frequencies of the involved resonators, or the locations of the involved resonators. As a result, energy transfer between multiple devices can be dynamically adjusted in response to external factors such as change in positions, orientations, or addition of resonators.

Power refers to the rate at which energy is transferred. Accordingly, it is understood description relating to energy transfer can be related to power transfer, and vice versa.

Unless otherwise defined, all technical and scientific terms used herein have the same meaning as commonly understood by one of ordinary skill in the art to which this disclosure belongs. In case of conflict with publications, patent applications, patents, and other references mentioned or incorporated herein by reference, the present specification, including definitions, will control. Any of the features described above may be used, alone or in combination, without departing from the scope of this disclosure. Other features, objects, and advantages of the systems and methods disclosed herein will be apparent from the following detailed description and figures.

### BRIEF DESCRIPTION OF THE DRAWINGS

FIG. 1a is a schematic of a resonator.

FIGS. 2a-c are examples of resonators.

FIGS. 3a and 3b are examples of resonators.

FIGS. 4a-c shows an example of a resonator with its characteristics size, thickness and width indicated.

FIG. 5 shows a schematic of a resonator in presence of a load.

FIG. 6 shows a schematic of a resonator in presence of a perturbation.

FIG. 7 is a schematic of an example arrangement of wireless energy transfer.

FIG. 8 is a plot of efficiency, η, vs. strong coupling factor, U=κ\sqrt{ΓₛΓ_{d}}=k\sqrt{QₛQ_{d}}.

FIG. 9 is a schematic of an example arrangement of wireless energy transfer.

FIGS. 10a-d are example arrangements of wireless energy transfer.

FIG. 11a is a schematic of an example arrangement of wireless energy transfer.

FIG. 11b is a plot of the energy transfer efficiency of the example shown in FIG. 11a.

FIG. 12a is a schematic of another example arrangement of wireless energy transfer.

FIG. 12b is a plot of the energy transfer efficiency of the example shown in FIG. 12a.

FIG. 13a is a schematic of another example arrangement of wireless energy transfer.

FIG. 13b is a plot of the energy transfer efficiency of the example shown in FIG. 13a.

FIG. 13c is a schematic of another example arrangement of wireless energy transfer.

FIG. 14a is a schematic of another example arrangement of wireless energy transfer.

FIG. 14b is a plot of the average efficiency of the example shown in FIG. 14a.

FIG. 14c is a plot of the energy transfer efficiency as a function of xy position for the example shown in FIG. 14a.

FIG. 14d is a plot of the energy transfer efficiency at several positions for the example shown in FIG. 14a.

FIG. 15a is a schematic of another example arrangement of wireless energy transfer.

FIG. 15b is a plot of the average efficiency of the example shown in FIG. 15a.

FIG. 15c is a plot of the energy transfer efficiency as a function of xy position for the example shown in FIG. 15a.

FIG. 15d is a plot of the energy transfer efficiency at several positions for the example shown in FIG. 15a.

FIG. 16a is a schematic of another example arrangement of wireless energy transfer.

FIG. 16b is a plot of the average efficiency of the example shown in FIG. 16a.

FIG. 16c is a plot of the energy transfer efficiency as a function of xy position for the example shown in FIG. 16a.

FIG. 16d is a plot of the energy transfer efficiency at several positions for the example shown in FIG. 16a.

FIG. 17a is a schematic of another example arrangement of wireless energy transfer.

FIG. 17b shows plots of energy transfer efficiency spectra and impedance spectra of the example shown in FIG. 17a.

FIG. 18a is a schematic of another example arrangement of wireless energy transfer.

FIG. 18b shows plots of energy transfer efficiency spectra and impedance spectra of the example shown in FIG. 18a.

FIG. 19a is a schematic of another example arrangement of wireless energy transfer.

FIG. 19b shows plots of energy transfer efficiency spectra and impedance spectra of the example shown in FIG. 19a.

FIG. 20 is a flow chart depicting an example process for wireless energy transfer.

FIG. 21 is a flow chart depicting another example process for wireless energy transfer.

FIGS. 22a-f illustrates examples of operating frequencies of power sources as a function of time.

FIG. 23 is a flow chart depicting another example process for wireless energy transfer.

FIG. 24 is a flow chart depicting another example process for wireless energy transfer.

FIG. 25 is a flow chart depicting another example process for wireless energy transfer.

FIG. 26 is a schematic showing an example of under the cabinet lighting application.

FIG. 27 is a schematic of a resonator enclosure.

FIG. 28 is a schematic of a desk environment.

FIG. 29 is a schematic of a resonator configured to operate in multiple operation modes.

FIG. 30 is a circuit block diagram of an example of a power and control circuitry for the resonator configured to operate in multiple operation modes.

FIG. 31 is a schematic of an example of a wireless floor system 3000.

Like reference numbers and designations in the various drawings indicate like elements.

### DETAILED DESCRIPTION

The methods and systems described herein can be implemented in many ways. Some useful implementations are described below. The scope of the present disclosure is not limited to the detailed implementations described in this section, but is described in broader terms in the claims.

Energy can be wirelessly transferred between a source resonator and a receiver resonator. Additional resonators, which function as repeater resonators, can be used to extend the range of energy transfer, allowing the distance between the source resonator and the receiver resonator to be increased. This specification also discloses techniques to control (e.g., enhance, or redistribute) the energy transfer between one or more source resonators and one or more receiver resonators. The control can be based on adjusting the operating frequency of a power source which provides energy to the one or more source resonators. In addition, or alternatively, the control can be achieved by adjusting the resonant frequencies or locations of the source, receiver, repeater resonators involved in the energy transfer.

Single Resonator

A resonator may be defined as a system that can store energy in at least two different forms (e.g., electric and magnetic fields), and where the stored energy is oscillating between the two forms. FIG. 1 illustrates a schematic of a resonator 102, which is capable of storing energy. Generally, the resonator 102 can have one or more resonances. A resonance of the resonator 102 has an oscillation mode with a resonant frequency f and a resonant field distribution. The resonant frequency f may refer to the frequency when the resonance can be excited most strongly with a given input stimulus. Angular resonant frequency ω is defined as ω=2πf and the resonant wavelength λ is defined as λ=c/f (where c is the speed of light.) Resonant period T is defined as T=1/f=2π/ω.

In the absence of loss mechanisms, coupling mechanisms or external energy supplying or draining mechanisms, total stored energy W of the resonator 102 would stay fixed. On the other hand, when the resonator 102 has intrinsic losses (e.g., radiation damping, absorption losses), the stored energy decays. Resonant fields of the resonator 102 can be represented according to Eq. (1), shown below:

$$\frac{d a ( t )}{d t} = - i ( ω - iΓ ) a ( t ) , \qquad ( 1 )$$

where the variable a(t) is the resonant field amplitude, defined so that the energy contained within the resonator is given by |a(t)|². Γ is the intrinsic amplitude decay or loss rate (e.g. due to absorption and radiation losses) of the resonant fields. Γ or Q may be measured by a Standing-Wave Ratio (SWR) analyzer.

The resonator 102 can also be described to have a quality factor Q (also referred to as the “Q-factor”) for the given resonance. The Q characterizes the energy decay and is inversely proportional to the energy losses. The Q can be defined as Q=ω*W/P, where P is the time-averaged power lost at steady state. As such, when the resonator 102 has a high-Q, the resonator 102 has relatively low intrinsic losses and can store energy for a relatively long time. Because the resonator 102 loses energy at its intrinsic energy decay or energy loss rate, 2Γ, its Q, also referred to as its intrinsic Q, is given by Q=ω/2Γ. The bandwidth of the resonator 102 is given by Δω=2Γ or Δf=Γ/π. For example, Δf may refer to the width of frequencies for which the energy is at least half of its peak value when excited by a stimulus. When Q=100, Δf=f/Q=0.01 f. The Q can be related to the number of oscillation periods for the energy to decay by a factor of e. The Q can be expressed as Eq. (2), shown below:

Q=ωL/R_{abs}+R_{rad}) (2)

where R_{rad} is the radiative loss and R_{abs} is the absorption loss of the resonator 102.

As described above, Q is related to intrinsic loss mechanisms (e.g., radiation damping, absorption losses.) A subscript index can be used to indicate the resonator to which the Q refers. For example, FIG. 1 shows the (intrinsic) quality factor Q₁ of the resonator 102 (resonator 1 in this case) labeled according to this convention.

Examples of a Resonator

A resonator 102 can be an electromagnetic resonator, which can include an inductive element, a distributed inductance, or a combination of inductances with inductance, L, and a capacitive element, a distributed capacitance, or a combination of capacitances, with capacitance, C. The electromagnetic resonator can be described to be a magnetic resonator or an electric resonator. For example, a magnetic resonator can have energy stored by the electric field to be primarily confined within its structure and the energy stored by the magnetic field to be primarily in the region surrounding its structure. In this case, the magnetic resonator can be used to transfer energy primarily by the resonant magnetic near-field. As another example, an electric resonator can have energy stored by the magnetic field to be primarily confined within its structure and that the energy stored by the electric field to be primarily in the region surrounding its structure. In this case, the electric resonator can be used to transfer energy primarily by the resonant electric near-field.

The total electric and magnetic energies stored by the resonator may be equal, but with different spatial field distributions. For example, the ratio of the average electric field energy to the average magnetic field energy specified at a distance (e.g., 1L, 2L, 3L, 5L, where L is the characterize size described below) from the center of a resonator 102 can be 1 or larger (e.g., 2 or larger, 5 or larger, 10 or larger, 100 or larger.) As another example, the ratio of the average magnetic field energy to the average electric field energy specified at a distance (e.g., 1L, 2L, 3L, 5L) from the center of the resonator 102 can be 1 or larger (e.g., 2 or larger, 5 or larger, 10 or larger, 100 or larger.) In some implementations, the electromagnetic resonator is capable of storing electromagnetic energy.

FIGS. 2a-c illustrates examples of a resonator 102. FIG. 2a shows an example of a capacitively-loaded loop inductor, which may be a magnetic resonator. x is the radius of the enclosed circular surface area and a is the radius of the conductor used to from loop 202. Loop 202 can provide an inductance and capacitor 204 can provide a capacitance to a resonator 102. In parts of this specification, the capacitively-loaded loop inductor may be illustrated as an example of resonator 102. FIG. 2b shows an example of multi-turn conductor, which may be a magnetic resonator. h is the height of the multi-turn conductor. The capacitance may be distributed and be realized between adjacent windings of multiple turns of wire. FIG. 2c shows an example of an electric resonator, where a is the radius of the conducting rod and h is the half length of the rod.

Terms such as “loop” or “coil” used herein are used to indicate a conducting structure (e.g., Litz wire, wire, tube, strip, etc.), which encloses a surface of any shape and dimension, with any number of turns. It will be understood, that resonator 102 may be other types of resonators other than those shown in FIGS. 2a-c.

FIGS. 3a and 3b illustrate examples of a resonator 102, which can include one or more inductors and one or more capacitors. In these examples, inductor 310 indicates an inductive element and capacitor 312 indicates a capacitive element. It is understood that, electromagnetic resonators (including those of FIGS. 2a-c) can be schematically described by the circuits shown in FIGS. 3a and 3b. Provided with initial energy, such as electric field energy stored in the capacitor 312, energy in the resonator 102 can oscillate as the capacitor 212 discharges and transfers energy into magnetic field energy stored in the inductor 310 which in turn transfers energy back into electric field energy stored in the capacitor 312 and so on.

FIG. 3a shows an example of a resonator 102, where an inductor 310 and a capacitor 312 form a closed circuit. Energy can be transferred in or out of the resonator 102 by physically connecting a power source or a load device to the resonator 102. Alternatively, energy may be transferred to or from the resonator 102 in a non-contact manner (e.g., inductive manner.) FIG. 3b shows another example of a resonator 102, where an inductor 310 and a capacitor 312 forms an open circuit. In this example, energy can be transferred to or from the resonator 102 by physically connecting a power source or load device to the two ends 314 and 316 and forming a closed loop. Alternatively, additional circuit elements may be added to close the circuit of the resonator 102, and then energy may be transferred in a non-contact manner.

In some implementations, a resonator 102 can include resistors, diodes, switches, amplifiers, diodes, transistors, transformers, conductors, connectors and the like.

Resonant Frequency

In some implementations, the angular resonant frequency ω of a resonator 102 can be expressed as Eq. (3), shown below:

$$\begin{matrix}ω = 2 π f \\ = \sqrt{\frac{1}{LC}} .\end{matrix} \qquad ( 3 )$$

where L represents the inductance and C represents the capacitance of the resonator 102. The resonant frequency can be changed by changing the inductance L and/or the capacitance C.

In some implementations, at least some portion of L and/or C of the resonator 102 may be tunable. The resonator frequency may be designed to operate at the so-called ISM (Industrial, Scientific and Medical) frequencies as specified by the FCC. The resonator frequency may be chosen to meet certain field limit specifications, specific absorption rate (SAR) limit specifications, electromagnetic compatibility (EMC) specifications, electromagnetic interference (EMI) specifications, component size, cost or performance specifications, and the like.

Characteristic Size of a Resonator

Energy transfer between two resonators may occur for mid-range distances larger than the characteristic dimension of the smallest of the resonators involved in the transfer, where the distances are measured from the center of one resonator structure to the center of the other resonator.

FIG. 4a shows an example of a resonator 102 with characteristic size, x_{char}, (or, L), 402 defined to be the radius of the smallest sphere that can fit around the resonator 102. The center of the resonator structure 102 is the center of the sphere. FIG. 4b shows an example of a resonator 102 with characteristic thickness, t_{char}, 404 that is defined to be the smallest possible height of the highest point of the resonator 102, measured from a flat surface on which it is placed. FIG. 4c shows an example of a resonator 102 with characteristic width, w_{char}, 406 of a resonator 102 defined to be the radius of the smallest possible circle through which the resonator 102 may pass while traveling in a straight line. For example, the characteristic width 406 of a cylindrical resonator may be the radius of the cylinder.

Loaded Resonator

In some implementations, extraneous objects and/or additional resonators in the vicinity of a resonator 102 may perturb or load the resonator 102, thereby perturbing or loading the Q of the resonator 102. FIG. 5 illustrates a schematic of a resonator system 500 including a resonator 102 which is “loaded” by an object 502 (e.g., power source, load device.) The object 502 can couple to the resonator 102 either by a contact and/or non-contact manner. The amount of load can depend on a variety of factors such as the distance between the resonator 102 and the object 502, other extraneous objects and/or additional resonators, the material composition of extraneous objects and/or additional resonators, the structure of the resonator 102, the power in the resonator 102, and the like. Unintended external energy losses or coupling mechanisms to extraneous objects in the vicinity of the resonator 102 may be referred to as “perturbing” the Q of the resonator 102, and may be indicated by a subscript within rounded parentheses, Q. Intended external energy losses, associated with energy transfer via coupling to additional resonators and to generators and loads in the wireless energy transfer system may be referred to as “loading” the Q of the resonator, and may be indicated by a subscript within square brackets, [ ].

The Q of a resonator system 500 with a resonator 102 connected or coupled to a power generator, g, or load 502, l, may be called the “loaded quality factor” or the “loaded Q” and may be denoted by Q_{[g]} or Q_{[l]}, as illustrated in FIG. 5. In some implementations, there may be more than one generator or load connected to a resonator 102. The subscripts “g” and “l” can be used to refer to the equivalent circuit loading imposed by the combinations of generators and loads. The subscript “l” may refer to either generators or loads connected to the resonators.

The “loading quality factor” or the “loading Q” may be used to describe herein the resulting Q of the resonator system 500 due to a power generator or load connected to the resonator, as δQ_{[l]}, where, 1/δQ_{[l]}≡1/Q_{[l]}−1/Q. Larger the loading Q, δQ_{[l]}, of a generator or load, the less the loaded Q, Q_{[l]}, deviates from the unloaded Q of the resonator 102.

FIG. 6 shows a resonator system 600. The Q of the resonator system 500 in the presence of an extraneous object 602, p, that is not intended to be part of the energy transfer system may be called the “perturbed quality factor” or the “perturbed Q” and may be denoted by Q₍ₚ₎, as illustrated in FIG. 6. In general, there may be many extraneous objects, denoted as p1, p2, etc., or a set of extraneous objects {p}, that perturb the Q of the resonator 102. In this case, the perturbed Q may be denoted Q_{(p1+p2+ . . . )} or Q_{({p})}. For example, Q_{1(brick+wood)} may denote the perturbed quality factor of a first resonator 102 in a system for wireless energy transfer in the presence of a brick and a piece of wood, and Q_{2({office})} may denote the perturbed quality factor of a second resonator 201 in a system for wireless energy transfer in an office environment.

The “perturbing quality factor” or the “perturbing Q” refers to the resulting Q of the resonator system 500 due to an extraneous object, p, as δQ₍ₚ₎, where 1/δQ₍ₚ₎≡1/Q₍ₚ₎−1/Q. As stated before, the perturbing quality factor may be due to multiple extraneous objects, p1, p2, etc. or a set of extraneous objects, {p}. The larger the perturbing Q, δQ₍ₚ₎, of an object, the less the perturbed Q, Q₍ₚ₎, deviates from the unperturbed Q of the resonator.

The “quality factor insensitivity” or the “Q-insensitivity” of a resonator 102 in the presence of an extraneous object 502 is defined as Θ₍ₚ₎=Q₍ₚ₎/Q. A subscript index, such as Θ₁₍ₚ₎, indicates the resonator to which the perturbed and unperturbed quality factors are referring, namely, Θ₁₍ₚ₎≡Q₁₍ₚ₎/Q₁.

Note that quality factor, Q, may also be characterized as “unperturbed”, when necessary to distinguish it from the perturbed quality factor, Q₍ₚ₎, and “unloaded”, when necessary to distinguish it from the loaded quality factor, Q_{[l]}. Similarly, the perturbed quality factor, Q₍ₚ₎, may also be characterized as “unloaded”, when necessary to distinguish them from the loaded perturbed quality factor, Q_{(p)[l]}.

In some implementations, the intrinsic Q of a resonator 102 can be deduced by measuring the energy that the resonator 102 receives from a power source as a function of frequency. For example, the observed full-width-half maximum (FWHM) of the measured spectra may be related to Q.

Energy Transfer Between Two Resonators

FIG. 7 shows an example arrangement of an energy transfer scheme 700 between a source resonator 702 and a receiver resonator 704 with a separation D. A power source 710 is coupled to the source resonator 702 through an impedance matching circuit 712, which is used to tune the impedance matching condition between the power source 710 and the source resonator 702. Coupling between the power source 710 and the impedance matching circuit 712 can be achieved through physical contact or in a non-contact manner. Similarly, coupling between the impedance matching circuit 712 and the source resonator 702 can be achieved through physical contact or in a non-contact manner. In some implementations, the power source 710 is directly coupled (e.g., physical contact or in a non-contact manner) to the source resonator 702 without the impedance matching circuit 710. In these implementations, the energy coupling between the power source 710 and the source resonator 702 can be controlled by adjusting the arrangement (e.g., alignment, orientation, separation) between these two elements using an adjustment unit (not shown.) Similarly, the receiving resonator 704 can be coupled to a load device 720 (which consumes energy) through an impedance matching circuit 722. Similar features can be applied as described for the relation between the impedance matching circuit 712, power source 710, and source resonator 102.

It is understood that that the source resonator 702 and the receiver resonator 704 each can be any type of resonator 102 described above. In some implementations, a power source 702 can include a power generator, a solar panel, and/or a battery. A load device can include a load resistor, a mobile device, a lighting device, and/or a battery.

Energy transfer between the source resonator 702 and the receiver resonator 704 can be described using coupled mode theory (CMT.) In coupled mode theory, the resonator fields obey the following set of linear equations Eq. (4), shown below:

$$\frac{d {a}_{m} ( t )}{d t} = - i ( {ω}_{m} - {iΓ}_{m} ) {a}_{m} ( t ) + i {\sum }_{n \neq m}^{ } {κ}_{mn} {a}_{n} ( t ) \qquad ( 4 )$$

where the indices denote different resonators and κₘₙ are the coupling coefficients between the resonators. For a reciprocal system, the coupling coefficients may obey the relation κₘₙ=κₙₘ. Note that, for the purposes of the present specification, far-field radiation interference effects will be ignored and thus the coupling coefficients will be considered real. Furthermore, since in all subsequent calculations of system performance in this specification the coupling coefficients appear only with their square, κₘₙ², we use κₘₙ to denote the absolute value of the real coupling coefficients.

Note that the coupling coefficient, κₘₙ, from the CMT described above is related to the so-called coupling factor, kₘₙ, between resonators m and n by kₘₙ=2κₘₙ/\sqrt{ωₘωₙ}. The “strong-coupling factor”, Uₘₙ, is defined as the ratio of the coupling and loss rates between resonators m and n, by Uₘₙ=κₘₙ/\sqrt{ΓₘΓₙ}=kₘₙ\sqrt{QₘQₙ}.

The quality factor of a resonator m, in the presence of a similar frequency resonator n or additional resonators, may be loaded by that resonator n or additional resonators, in a fashion similar to the resonator being loaded by a connected power generating or consuming device. The fact that resonator m may be loaded by resonator n and vice versa is simply a different way to see that the resonators are coupled.

The loaded Q's of the resonators in these cases may be denoted as Q_{m[n]} and Q_{n[m]}. For multiple resonators or loading supplies or devices, the total loading of a resonator may be determined by modeling each load as a resistive loss, and adding the multiple loads in the appropriate parallel and/or series combination to determine the equivalent load of the ensemble.

In some implementations, “loading quality factor” or the “loading Qₘ” of resonator m due to resonator n is defined as δQ_{m[n]}, where 1/δQ_{m[n]}≡1/Q_{m[n]}−1/Qₘ. Note that resonator n is also loaded by resonator m and its “loading Qₙ” is given by 1/δQ_{n[m]}≡1/Q_{n[m]}−1/Qₙ.

When one or more of the resonators are connected to power generators or loads, the set of linear equations is modified as Eq. (5), shown below:

$$\frac{d {a}_{m} ( t )}{d t} = - i ( {ω}_{m} - {iΓ}_{m} ) {a}_{m} ( t ) + i {\sum }_{n \neq m}^{ } {κ}_{mn} {a}_{n} ( t ) - {κ}_{m} {a}_{n} ( t ) + \sqrt{2 {κ}_{m}} {s}_{+ m} ( t ) \\ {s}_{- m} ( t ) = \sqrt{2 {κ}_{m}} {a}_{m} ( t ) - {s}_{+ m} ( t ) , \qquad ( 5 )$$

where s₊ₘ(t) and s₋ₘ(t) are respectively the amplitudes of the fields coming from a generator into the resonator m and going out of the resonator m either back towards the generator or into a load, defined so that the power they carry is given by |s₊ₘ(t)|² and |s₋ₘ(t)|². The loading coefficients κₘ relate to the rate at which energy is exchanged between the resonator m and the generator or load connected to it.

Note that the loading coefficient, κₘ, from the CMT described above is related to the loading quality factor, δQ_{m[l]}, defined earlier, by δQ_{m[l]}=ωₘ/2κₘ.

The “strong-loading factor”, U_{m[l]}, is defined as the ratio of the loading and loss rates of resonator m, U_{m[l]}=κₘ/Γₘ=Qₘ/δQ_{m[l]}.

Referring to FIG. 7, work may be extracted from the receiver resonator 704 by the load device 720. In the following, subscripts “s” for the source resonator 702, “d” for the receiving resonator 704 (also referred as, “g” for the power source 710, and “1” for the load device 720. In this example, κ_{sd}=κ_{ds} because there are only two resonators, and in the following, indices on κ_{sd}, k_{sd}, and U_{sd} are dropped as κ, k, and U, respectively. In the following description of CMT, the power source 710 is considered to be directly coupled to the source resonator 702, and the receiver resonator 704 is considered to be directly connected to the load device 720, without impedance matching circuits 712 and 722.

The power source 710 may be constantly driving the source resonator 702 at a constant operating frequency, fₒ, corresponding to an angular operating frequency, ωₒ, where ωₒ=2πfₒ.

In this case, the efficiency, η=|s_{-d}|²/|s_{+d}|², of the power transmission from the power source 710 to the load device 720 (via the source and receiver resonators) is maximized under the following conditions: The source resonant frequency, the device resonant frequency and the generator operating frequency have to be matched, namely ωₛ=ω_{d}=ωₒ.

Furthermore, the loading Q of the source resonator 702 due to the power source 710, δQ_{s[g], should be matched (equal) to the loaded Q of the source resonator 710 due to the receiver resonator 704 and the load, Q}_{s[dl]}, and inversely the loading Q of the receiver resonator 704 due to the load, δQ_{d[l]}, should be matched (equal) to the loaded Q of the receiver resonator 704 due to the source resonator 702 and the power source 710, Q_{d[sg]} namely δQ_{[sg]}=Q_{s[dl]} and δQ_{d[l]}=Q_{d[sg]}.

These equations determine the optimal loading rates of the source resonator 702 by the power source 710 and of the receiver resonator 720 by the load as Eq. (6), shown below:

$$\begin{matrix}{U}_{d [ l ]} = {κ}_{d} / {Γ}_{d} \\ = {Q}_{d} / δ {Q}_{d [ l ]} \\ = \sqrt{1 + {U}^{2}} \\ = \sqrt{1 + {( κ / \sqrt{{Γ}_{s} {Γ}_{d}} )}^{2}} \\ = {Q}_{s} / δ {Q}_{s [ g ]} \\ = {κ}_{s} / {Γ}_{s} \\ = {U}_{s [ g ]} .\end{matrix} \qquad ( 6 )$$

Note that the above frequency matching and Q matching conditions are together known as “impedance matching” in electrical engineering.

Under the above conditions, the maximized efficiency is a monotonically increasing function of only the strong-coupling factor, U=κ/\sqrt{ΓₛΓ_{d}}=\sqrt{QₛQ_{d}}, between the source and receiver resonators and is given by, η=U²/(1+\sqrt{1+U²}, as shown in FIG. 8. Note that the coupling efficiency, η, is greater than 1% when U is greater than 0.2, is greater than 10% when U is greater than 0.7, is greater than 17% when U is greater than 1, is greater than 52% when U is greater than 3, is greater than 80% when U is greater than 9, is greater than 90% when U is greater than 19, and is greater than 95% when U is greater than 45. In some applications, the regime of operation where U>1 may be referred to as the “strong-coupling” regime.

Because a large U=κ/\sqrt{ΓₛΓ_{d}}=(2κ/\sqrt{ωₛω_{d}}) \sqrt{QₛQ_{d}} is desired in certain circumstances, source resonator 702 and receiver resonator 704 may be used that are high-Q. The Q of each resonator 702 and 704 may be high. The geometric mean of the resonator Q's, \sqrt{QₛQ_{d}} may also or instead be high.

The coupling factor, k, is a number between 0≦k≦1, and it may be independent (or nearly independent) of the resonant frequencies of the source resonator 702 and receiver resonator 704, rather it may determined mostly by their relative geometry and the physical decay-law of the field mediating their coupling. In contrast, the coupling coefficient, κ=k \sqrt{ωₛω_{d}}/2, may be a strong function of the resonant frequencies. The resonant frequencies of the resonators 702 and 704 may be chosen preferably to achieve a high Q rather than to achieve a low Γ, as these two goals may be achievable at two separate resonant frequency regimes.

In some implementations, a high-Q resonator 102 may be defined as one with Q>100. Two coupled resonators may be referred to as a system of high-Q resonators when each resonator has a Q greater than 100, Qₛ>100 and Q_{d}>100. In other implementations, two coupled resonators may be referred to as a system of high-Q resonators when the geometric mean of the resonator Q's is greater than 100, \sqrt{QₛQ_{d}}>100.

Energy transfer can occur efficiently over a wide range of distances, but the technique is distinguished by the ability to exchange useful energy for powering or recharging devices over mid-range distances and between resonators with different physical dimensions, components and orientations. Note that while k may be small in these circumstances, strong coupling and efficient energy transfer may be realized by using high-Q resonators to achieve a high U, U=k\sqrt{QₛQ_{d}} (where Qₛ and is the quality factor of one resonator and Qₛ is the quality factor of another resonator) in Q may be used to at least partially overcome decreases in k, to maintain useful energy transfer efficiencies.

While the near-field of a single resonator may be described as omni-directional, the efficiency of the energy exchange between two resonators may depend on the relative position and orientation of the resonators. The efficiency of the energy exchange may be maximized for particular relative orientations of the resonators. The sensitivity of the transfer efficiency to the relative position and orientation of two uncompensated resonators may be captured in the calculation of either k or κ. While coupling may be achieved between resonators that are offset and/or rotated relative to each other, the efficiency of the exchange may depend on the details of the positioning and on any feedback, tuning, and compensation techniques implemented during operation.

In some implementations, even though certain frequency and Q matching conditions may optimize the system efficiency of energy transfer, these conditions may not need to be exactly met in order to have efficient enough energy transfer for a useful energy exchange. Efficient energy exchange may be realized so long as the relative offset of the resonant frequencies (|ωₛ−ω_{d}|/\sqrt{ωₛω_{d}}) is less than approximately the maximum among 1/Qₛ₍ₚ₎, 1/Q_{d(p)} and k_{sd(p)}. The Q matching condition may be less critical than the frequency matching condition for efficient energy exchange. The degree by which the strong-loading factors, U_{m[l]}, of the resonators due to generators and/or loads may be away from their optimal values and still have efficient enough energy exchange depends on the particular system, whether all or some of the generators and/or loads are Q-mismatched and so on.

Resonant frequencies of the resonators 702 and 704 may not be exactly matched, but may be matched within Γₛ or Γ_{d} of the resonators 702 and 704. The strong-loading factors of at least some of the resonators due to a power source (e.g., generators) and/or loads may not be exactly matched to their optimal value. The voltage levels, current levels, impedance values, material parameters, and the like may not be at the exact values described in the disclosure but will be within some acceptable tolerance of those values. The system optimization may include cost, size, weight, complexity, and the like, considerations, in addition to efficiency, Q, frequency, strong coupling factor, and the like, considerations. Some system performance parameters, specifications, and designs may be far from optimal in order to optimize other system performance parameters, specifications and designs.

In some implementations, at least some of the system parameters of energy transfer scheme 700 may be varying in time, for example because components, such as a source resonator 702 or receiver resonator 704, may be mobile or aging or because the loads may be variable or because the perturbations or the environmental conditions are changing etc. In these cases, in order to achieve acceptable matching conditions, at least some of the system parameters (e.g., separation distances, resonant frequencies) may need to be dynamically adjustable or tunable.

Near-Field Coupling

Referring back to FIG. 7, energy transfer between the source resonator 702 and the receiver resonator 704 can occur through near-fields. Either of the two resonators can be a sub-wavelength object. The physical dimensions of either of the two resonators 702 and 704 may be less than 70% (e.g., less than 50%, less than 25%, less 10%, less than 2%) the wavelength corresponding to the resonant frequency. In some implementations, the two resonators 702 and 704 can be sub-wavelength magnetic resonators, and energy can be transferred through magnetic near-fields surrounding the two resonator 702 and 704. These near-fields may also be described as stationary or non-propagating because they do not radiate away from the resonator. In other words, the energy transfer between two resonators can occur through non-radiative fields.

The extent of the near-field in the area surrounding a resonator 102 is typically less than 100% (e.g., less than 75%, less than 50%, less than 25%) of the resonant wavelength, so the near-field may extend well beyond the resonator itself for a sub-wavelength resonator. The limiting surface, where the field behavior changes from near-field behavior to far-field behavior may be called the “radiation caustic”.

The strength of the near-field is reduced the farther one gets away from the resonator 102. While the field strength of the near-fields decays away from the resonator 102, the fields may still interact with objects brought into the general vicinity of the resonator. The degree to which the fields interact depends on a variety of factors, some of which may be controlled and designed, and some of which may not. The wireless energy transfer schemes described herein may be realized when the distance between coupled resonators is such that one resonator lies within the radiation caustic of the other.

Energy Transfer Using Repeater Resonators

FIG. 9 shows a schematic of a wireless energy transfer scheme 900. A power source 710 provides energy to a source resonator 702, which wirelessly transfers energy to one or more repeater resonators 706. A receiving resonator 704 receives energy from one or more repeater resonators 706. The source resonator 702 can provide energy by an oscillating field (e.g., electric, magnetic field), which induces electrical currents in the one or more repeater resonators 706. These induced electrical currents create their own oscillating field (e.g., electric, magnetic field), which further induces electric currents on other adjacent repeater resonators 706 and/or the receiver resonator 704. As a result, the repeater resonators 706 can extend the range of wireless energy transfer from the source resonator 702 to the receiver resonator 704. In some implementations, energy is transferred through multiple repeater resonators 706 before being received by the receiving resonator 704.

One or more repeater resonators 706 can be used to change, distribute, concentrate, enhance, and the like, the oscillating field (e.g., electric, magnetic field) generated by a source resonator 702. The repeater resonators 706 can be used to guide the oscillating fields around lossy and/or metallic objects that might otherwise block the oscillating fields. For example, the repeater resonators 706 can be used to eliminate or reduce areas of low power transfer, or areas of low magnetic field around a source. The repeater resonators 706 can be used to improve the coupling efficiency between a source and a target receiver resonator or resonators, and can be used to improve the coupling between resonators with different orientations, or whose dipole moments are not favorably aligned. The energy transfer between the resonators can occur through near-fields, in other words, non-radiative fields.

In some implementations, wireless energy transfer scheme 900 can include a monitor system 730 which measured an energy transfer response of any components (e.g., power source, load device, source, receiver, repeater resonators.) The measurements can be carried out through wireless communication (e.g. using WiFi, Bluetooth, near field communication (NFB)) between the monitor system 730 and the any components. Alternatively, the communication can be hard-wired. The scheme 900 can include a processor (not shown) which can analyze and compile measurement results obtained from the monitor system 730.

The wireless energy transfer scheme 900 can also include an adjustment system 740 which can move the position of the resonators or adjust the resonant frequency of the resonators. In some implementations, resonators may be moved by a person instead of using the adjustment system 740.

Multiple source resonators 702 can be included in the wireless transfer scheme 300. Similarly, multiple receiving resonators 704 can be included. When one or more receiver resonators 704 are moving, one or more repeater resonators 706 can be stationary to provide improved energy transfer (e.g., higher transfer efficiency, greater range) to the one or more receiver resonators. Alternatively, one or more receiver resonators 704 can be stationary, while one or more repeater resonators 706 are moving to provide improved energy transfer. A single repeater resonator 706 can provide energy to one or more receiver resonators 704.

Source, Receiver, Repeater Resonators

A resonator 102 may be considered as a source resonator 702, when it receives energy from a power source 310 (without a resonator in between) as shown in FIG. 9. A resonator may be considered as a receiving resonator 704, when its energy is drained by a load device 720 (without a resonator in between). A resonator may be considered as a repeater resonator 706 when it receives energy from a resonator and transfers the energy to another resonator. A resonator can function as any combination of a source resonator 702, a repeater resonator 706, and a receiver resonator 706.

In some implementations, a resonator may alternate between operating as a source resonator 702, a receiver resonator 704, or repeater resonator 706. For example, a receiver resonator 704 that is connected to load or electronic device may operate simultaneously, or alternately as a repeater resonator 706 for another device, repeater resonator, or receiver resonator. The alternation can be achieved by time multiplexing, frequency multiplexing, self-tuning, or through a centralized control algorithm. Multiple repeater resonators 706 can be positioned in an area and tuned in and out of resonance to achieve a spatially varying field (e.g., electric, magnetic field.) In some implementations, a local area of a strong field may be created by an array of resonators (e.g., source, receiver, repeater resonators), and the positioned of the strong field area may be moved around by changing electrical components or operating characteristics of resonators in the array.

Structure of Repeater Resonator

A repeater resonator 706 can be any type of resonator (e.g., LC circuit) as described for resonator 102 earlier.

In some implementations, a repeater resonator 706 may have dimensions, size, or configuration that is the same as a source resonator 702 or receiver resonator 704. The repeater resonator 706 may have dimensions, size, or configuration that is different than the source resonator 702 or receiver resonator 704. For example, the repeater resonator 706 may have a characteristic size that is larger than the receiver resonator 704 or larger than the source resonator 702, or larger than both. A larger repeater resonator may improve the coupling between the source and the repeater resonator at a larger separation distance between the source resonator 702 and the receiver resonator 704.

A repeater resonator 706 can include only inductive and capacitive components without any additional circuitry. Alternatively, the repeater resonator 706 can include additional control circuitry, tuning circuitry, measurement circuitry, or monitoring circuitry. For example, additional circuitry can be used to monitor the voltages, currents, phase, inductance, capacitance, and the like of the repeater resonator 706. Measured parameters of the repeater resonator can be used to adjust or tune the repeater resonator 706. controller or a microcontroller may be used by the repeater resonator 706 to actively adjust the capacitance, resonant frequency, inductance, resistance, and the like of the repeater resonator 706. The repeater resonator 706 may be adjusted prevent exceeding its voltage, current, temperature, or power limits. For example, the repeater resonator 706 may detune its resonant frequency to reduce the amount of power transferred to the repeater resonator 706, or to modulate or control how much power is transferred to other resonators that couple to the repeater resonator 706.

In some implementations, control and/or monitoring circuitry of a repeater resonator 706 may be powered by the energy received by the repeater resonator 706 from another resonator (e.g., source, receiver, repeater resonator.) In this case, although the control and/or monitoring may behave as a load, the repeater resonator 706 may be considered as a repeater resonator than a receiver resonator. The repeater resonator 706 can include AC to DC, AC to AC, or DC to DC converters and regulators to provide power to the control and/or monitoring circuitry. The repeater resonator 706 may include an additional energy storage component such as a battery or a super capacitor to supply power to the control and monitoring during momentary or extended periods of wireless power transfer interruptions. The battery, super capacitor, or other power storage component may be periodically or continuously recharged during normal operation when the repeater resonator 706 is within range of any source resonator 702.

The repeater resonator 706 can include communication or signaling capabilities such as WiFi, Bluetooth, NFB, and the like, that may be used to coordinate power transfer from one or more source resonators to a specific location or one or more repeater resonators 704. For example, multiple repeater resonators 706 can be spread across and be signaled to selectively tune or detune from a specific resonant frequency to extend the field (e.g., electric, magnetic field) from a source to a specific location, area, or resonator. For example, the selective tuning or detuning within a given resonator can be accomplished using variable capacitance, variable inductance, and/or variable geometry.

In some implementations, a repeater resonator 706 can include a device into which some, most, or all of the energy transferred or captured from a source resonator 704 may be available for use. The repeater resonator 706 can provide power to one or more electric or electronic devices (e.g., low power consumption devices, lights, LEDs, displays, sensors) included in the repeater resonator, while relaying or extending the range of the source.

Q-Factor

A repeater resonator 706 can have an intrinsic Q-factor of 50 or larger (e.g., 80 or larger, 100 or larger, 200 or larger, 300 or larger, 500 or larger, 1000 or larger.) In some implementations, a repeater resonator 706 can have an intrinsic quality factor Qᵣ satisfying \sqrt{QᵣQᵢ}>50 (e.g., \sqrt{QᵣQᵢ}>80, \sqrt{QᵣQᵢ}>100, \sqrt{QᵣQᵢ}>200, \sqrt{QᵣQᵢ}>500, \sqrt{QᵣQᵢ}>1000), where Qᵢ is an intrinsic quality factor of an adjacent resonator (e.g., source, receiving, or repeater resonator) which couples with the repeater resonator 706.

Example Arrangements

FIG. 10a shows an example arrangement where a repeater resonator 706 is positioned between a source resonator 702 and a receiver resonator 704 to extend the range of energy transfer from the source resonator 702. FIG. 10b shows an example arrangement where a repeater resonator 706 can be positioned after, and further away from a source 702 than a receiver resonator 704. In this case, it still may be possible to have more efficient energy transfer between the source resonator 702 and the receiver resonator 704 compared to if the repeater resonator 706 was not used. The repeater resonator 706 can be larger than the receiver resonator 704.

A repeater resonator 706 can be used to improve coupling between non-coaxial resonators or resonators whose dipole moments are not aligned for high coupling factors or energy transfer efficiencies. FIGS. 10c and 10d illustrates examples, where a repeater resonator 706 is used to enhance coupling between a source resonator 702 and a receiver resonator 704 that are not coaxially aligned. This is achieved by placing the repeater resonator 706 between the source resonator 702 and receiver resonator 704, and aligning the repeater resonator 706 with the receiver resonator 704 as shown in FIG. 10c, or aligning the repeater resonator 706 with the source resonator 702 as shown in FIG. 10d.

Frequency of Repeater Resonators

Resonant frequency of one or more source resonators 702, one or more receiver resonators 704, and one or more repeater resonators 706 can be chosen based on the arrangement or application of the wireless transfer scheme. For example, all of the resonators can have substantially similar (e.g., within 10%, 5%, 3%, 1% of each other) resonant frequencies. Alternatively, only a subgroup of resonators (e.g., multiple repeater resonators, a source resonator and one or more repeater resonators, source resonator and receiver resonator) may have substantially similar resonant frequencies.

In some implementations, a repeater resonator 706 can be tuned to have a resonant frequency that is substantially equal to that of the frequency of a source or device or at least one other repeater resonator 706 with which the repeater resonator 706 is designed to interact or couple. Alternatively, the repeater resonator 706 can be detuned to have a resonant frequency that is substantially greater than, or substantially less than the frequency of a source or device or at least one other repeater resonator 706 with which the repeater resonator is designed to interact or couple. In some implementations, a repeater resonator 706 can be a source resonator and/or a receiver resonator simultaneously, or it may be switched between operating modes of a source, receiver, or repeater resonator.

### Example 1

FIG. 11a shows an example arrangement of an energy transfer scheme 1100, where energy is transferred from a source resonator 702 to a receiver resonator 704 without any repeater resonator in between. A power source 710 (not shown) provides energy to the source resonator 702. FIG. 11b shows a plot 1150 of energy transfer efficiency for the energy transfer scheme 1100. In this specification, “energy transfer efficiency” refers to the ratio of energy received by a receiver resonator to the energy supplied by a source resonator. For example, in plot 1150 (and subsequent related plots), the energy transfer efficiency corresponds to the ratio of energy received by the receiver resonator 704 to the energy supplied by the source resonator 702, as a position of the receiver resonator 704 along the “line-x” in FIG. 11a. Receiver resonator position 0 corresponds to the case when the center of the receiver resonator 704 is located at the center 1110 of the source resonator 702. Receiver resonator position 0.5 corresponds to the case when the center of the receiver resonator 704 is located at the boundary position 1120 of the source resonator 702. Plot 1150 shows that the energy transfer efficiency tends to decrease when the receiver resonator 704 is further apart from the source resonator 702. The energy transfer range, which corresponds to the maximum distance from center 1110 of a location with energy transfer efficiency of at least 10%, is about at repeater resonator position 0.9. In some implementations, the energy transfer range can be defined as the maximum distance from center 1110 of a location with energy transfer efficiency of at least 20%, (e.g., at least 30%, at least 40%, at least 50%, at least 60%, at least 70%, at least 80%, at least 90%.) Around receiver resonator position 0.5, the energy transfer efficiency has a sharp drop, which is due to opposite oscillating field directions on the left and right side of boundary 1150. Such positions are referred as “dead spots” in this specification.

FIG. 12a shows an example arrangement of an energy transfer scheme 1200, where energy is transferred from a source resonator 702 to a receiver resonator 704 with one repeater resonator 706 in between. FIG. 12b shows a plot 1250 of the energy transfer efficiency for the energy transfer scheme 1200. Receiver resonator position 1.0 corresponds to the case when the center of the receiver resonator 704 is located at the center 1230 of the repeater resonator 706. Plot 1250 shows that the energy transfer efficiency tends to decrease with increasing receiver resonator position, but the energy transfer range is extended to about repeater resonator position 2.0 in comparison to the case of plot 1150, due to the use of repeater resonator 760. In this example, receiver resonator positions 0.5 and 1.5 correspond to dead spots 1160.

FIG. 13a shows an example arrangement of an energy transfer scheme 1300, where energy is transferred from a source resonator 702 to a receiver resonator 704 with two repeater resonators 706 in between. FIG. 13b shows a plot 1350 of the energy transfer efficiency for the energy transfer scheme 1300. The energy transfer range is further extended to about repeater resonator position 2.8. Plot 1350 also shows that the energy transfer efficiency at repeater resonator position 1.0 is about 5%, which is substantially reduced compared to the value of 85% shown in plot 1250. The reduction originates from the coupling between the two repeater resonators 706. Such positions are referred as “blind spots”, where a substantial reduction of energy transfer efficiency occurs by more than 20% (e.g., more than 40%, more than 60%, more than 80%) of the maximum energy transfer efficiency at that position due to the presence of an adjacent resonator.

In some implementations, the energy transfer efficiency drop at dead spots can be reduced by overlapping the area of adjacent source, receiver, and/or repeater resonators. FIG. 13c illustrates an example where a source receiver 702 partially overlaps with a first receiver resonator 706, which further overlaps with a second repeater resonator 706. The arrangement results in smearing out the sharp efficiency drop of dead spots. Such overlap can be adjusted when moving one or more of the resonators, while measuring the energy transfer response, which will be described later.

The energy transfer efficiency drop in blind spots can be controlled by adjusting the relative ratio of the operating frequency (also referred as fₒ or “driving frequency”) of a power source 710 to the resonant frequencies of a source, receiver, and/or repeater resonators. This aspect will be described in detail below. In this specification, the intrinsic resonant frequency of a source, a receiver, a repeater resonator may be referred as source resonant frequency (fₛ), receiver resonant frequency (f_{rc}), repeater resonant frequency (fᵣ), respectively. The intrinsic loss rate of a source, a receiver, a repeater resonator may be referred as Γₛ, Γ_{rc}, Γᵣ, respectively. Generally, operating frequency fₒ may or may not differ from fₛ, f_{rc} and/or fᵣ.

In some implementations, the characteristic size L_{rc} of the receiver resonator 704 can be smaller than the characteristic size Lᵣ₁ of at least one repeater resonator 706.

FIG. 14a shows an example arrangement of an energy transfer scheme 1400, where energy is transferred from a source resonator 702 to a receiver resonator 704 with one repeater resonators 706 on each side of the source resonator 702. In this example, the resonant frequencies of the source resonator 702 and the repeater resonators 706 are identical. A power source 710 (not shown in FIG. 14a) provides energy to the source resonator 702 at an operating frequency fₒ. FIG. 14b shows a plot 1410 of the average efficiency as a function of the ratio of the resonant frequency of the repeater resonators 706 (fᵣ) and operating frequency (fₒ). In this specification, average efficiency relates (e.g., proportional) to the integrated energy transfer efficiency divided by a fixed area (e.g., 100% of the area of interest, 120% of the area of interest, 150% of the area of interest.) In the example shown in FIG. 14b, the average efficiency is proportional to the spatially integrated energy transfer efficiency of FIG. 14c normalized by the shown area.

Plot 1410 shows that the average efficiency is optimum (e.g., maximum) when fᵣ/fₒ is larger than about 1.05 and not at 1.0 (fᵣ/fₒ). Accordingly, fₒ and/or fᵣ can be adjusted such that fᵣ/fₒ is larger than about 1.03 (e.g., about 1.05, about 1.08) to control (e.g., increase) the energy transfer efficiency. The optimum energy transfer does not occur at 1.0 (fᵣ/fₒ) due to coupling between adjacent repeater resonators 706. Alternatively, fₒ and/or fᵣ can be adjusted such that fₒ/fᵣ is larger than about 1.03 (e.g., about 1.05, about 1.08) to control the energy transfer efficiency using the coupling effect between adjacent resonators. It is understood that the ratio between fₒ and fₛ (or fₒ and f_{rc}) can be adjusted in a similar manner. FIG. 14c shows a plot of the (normalized) energy transfer efficiency as function of spatial location for energy transfer scheme 1400 at fᵣ/fₒ=1.15.

Referring FIG. 14d, plot 1430 shows the energy transfer efficiency as a function of fᵣ/fₒ for several locations of the receiver resonator 704. Curve 1432 shows the energy transfer efficiency when the receiver device is located at (x, y)=(1,0) or (−1,0) for the x, y coordinates presented in FIG. 14c. Curve 1434 shows the energy transfer efficiency when the receiver device is located at (x, y)=(0,0). Similar to the discussions for the average efficiency, the energy transfer efficiency can increase as fᵣ/fₒ deviates from 1. Similar analysis for plot 1430 can be done for plot 1410.

FIG. 15a shows an example arrangement of an energy transfer scheme 1500, where energy is transferred from a source resonator 702 to a receiver resonator 704 with two repeater resonators 706 on each side of the source resonator 702. FIG. 15b shows a plot 1510 of the average efficiency as a function of fᵣ/fₒ. In this example, the average efficiency is proportional to the spatially integrated energy transfer efficiency of FIG. 15c normalized by the shown area. The maximum average efficiency is around 1.05 fᵣ/fₒ. The average efficiency increases when fᵣ/fₒ deviates from 1. Accordingly, in some implementations, either of the operating frequency or the resonant frequencies of resonators can be adjusted away from each other such that the efficiency (e.g., average efficiency) increases.

FIG. 15c shows a plot of the (normalized) energy transfer efficiency as function of spatial location for energy transfer scheme 1500 at fr/fo=1.25.

Referring FIG. 15d, plot 1530 shows the energy transfer efficiency as a function of fᵣ/fₒ for several locations of the receiver resonator 704. Curve 1532 shows the energy transfer efficiency when the receiver device is located at (x, y)=(0,0) for the x, y coordinates presented in FIG. 15c. Curve 1534 shows the energy transfer efficiency when the receiver device is located at (x, y)=(1,0) or (−1,0). Curve 1536 shows the energy transfer efficiency when the receiver device is located at (x, y)=(2,0) or (−2,0). The curves 1532-1536 indicate that the energy transfer efficiency can be maximum when fᵣ/fₒ deviates from 1. Similar analysis for plot 1530 can be done for plot 1510.

FIG. 16a shows an example arrangement of an energy transfer scheme 1600, where energy is transferred from a source resonator 702 to a receiver resonator 704 with eight repeater resonators 706 adjacent to the source resonator 702. FIG. 16b shows a plot 1610 of the average efficiency as a function of fᵣ/fₒ. In this example, the average efficiency is proportional to the spatially integrated energy transfer efficiency of FIG. 15c normalized by the shown area. The average efficiency is largest around 1.1 fᵣ/fₒ and around 1.25 fᵣ/fₒ. FIG. 16c shows a plot of the (normalized) energy transfer efficiency as function of spatial location for energy transfer scheme 1600 at fᵣ/fₒ=1.3.

Referring FIG. 16d, plot 1630 shows the energy transfer efficiency as a function of fᵣ/fₒ for several locations of the receiver resonator 704. Curve 1632 shows the energy transfer efficiency when the receiver device is located at (x, y)=(0,0) for the x, y coordinates presented in FIG. 16c. Curve 1634 shows the energy transfer efficiency when the receiver device is located at (x, y)=(1,0), (−1,0), (0,1) or (0, −1). Curve 1636 shows the energy transfer efficiency when the receiver device is located at (x, y)=(1,1), (−1,1), (1, −1) or (−1, −1). The curves 1632-1636 indicate that the energy transfer efficiency can be maximum when fᵣ/fₒ deviates from 1. Similar analysis for plot 1630 can be done for plot 1610.

A power source 710 can be configured to provide energy to a source resonator 702 at an operating frequency fₒ that is adjustable. The fₒ can be adjusted such that fₒ is different from the source resonant frequency fₛ. The difference can be equal or larger than, Γ (or bandwidth Δf) of the source resonator 702. In some implementations, fₒ can be adjusted such that fₒ is different from the repeater (or receiver) resonant frequency fₛ (or f_{rc}) such that the difference is equal or larger than, Γ of the repeater (or receiver) resonator 706 (704.) In other words, any of fₒ, fₛ, fᵣ, f_{rc} can be adjusted such that |fᵣ−fₒ|, |fₛ−fₒ|, or |f_{rc}−fₒ| is equal or larger than the loss rate (Γ) of either the source, repeater, or receiver resonators. After the adjustment, the energy transfer efficiency of a receiver resonator 706 at a location can be larger than the energy transfer efficiency when |fᵣ−fₒ|, |fₛ−fₒ|, or |f_{rc}−fₒ|=0. In some implementations, after the adjustment, the average efficiency can be larger than the average efficiency when |fᵣ−fₒ|, |fₛ−fₒ|, or |f_{rc}−fₒ|=0.

In some implementations, any of fₒ, fₛ, fᵣ, f_{rc} can be adjusted to control energy transfer efficiency between a source resonator 702 and a receiver resonator 706. For example, fᵣ/fₒ, fₒ/fᵣ, fₛ/fₒ, fₒ/fₛ, f_{rc}/fₒ or fₒ/f_{rc} can be adjusted to be 1.01 or larger (e.g., 1.03 or larger, 1.05 or larger, 1.08 or larger, 1.0 or larger, 1.1 or larger, 1.2 or larger). After the adjustment, the energy transfer efficiency of a receiver resonator 706 at a location can be larger than the energy transfer efficiency when fᵣ/fₒ, fₛ/fₒ, or f_{rc}/fₒ=1. In some implementations, the average efficiency can be larger the average efficiency when fᵣ/fₒ, fₛ/fₒ, or f_{rc}/fₒ=1. Moreover, any of fₒ, fₛ, fᵣ, f_{rc} can be adjusted such that |fᵣ−fₒ|, |fₛ−fₒ|, or |f_{rc}−fₒ| is 0.01 fₛ or larger (e.g., 0.03 or larger, 0.05 fₛ or larger 0.08 fₛ or larger, 1.0 fₛ or larger, 1.5 fₛ or larger, 2.0 fₛ or larger.)

A spectrum of an energy transfer efficiency such as those in plots 1430, 1530 or 1630 may be referred as “energy transfer efficiency spectrum.” The operating frequency or any of the resonant frequencies can be adjusted such that fᵣ/fₒ satisfies a point in the energy transfer efficiency spectrum that avoids a dip in the spectrum. For example, for curve 1534, fᵣ/fₒ=1.05 can be chosen, where the dip is avoided. In some implementations, the operating frequency or any of the resonant frequencies can be adjusted such that the fᵣ/fₒ satisfies a point in the energy transfer efficiency spectrum which has a substantially small slope. For example, fᵣ/fₒ can be adjusted such that, when the operating frequency varies by 5% (e.g., 2%) of itself, the energy transfer efficiency can vary less than 10% (e.g., less than 5%, less than 3%) of itself. The energy transfer efficiency can be larger than 30% (e.g., larger than 50%, larger than 80%). For example, at least some of the plots in FIGS. 14c, 14d, 15c, 15d, 16c and 16d show f₁/fₒ values satisfying these features.

It is understood that the disclosed techniques are applicable, when the resonant frequencies of a source resonator 702 and the repeater resonators 706 are substantially similar (e.g. within 10% of each other.)

As previously mentioned, coupling between adjacent resonators can be described using the coupled mode theory. As shown in above examples, the spatial distribution of the resonators can cause a receiving resonator 704 to have an energy transfer efficiency η1 when the operating frequency differs from at least one of the resonant frequencies of the resonators (e.g., source, receiver, and/or repeater resonators) by more than 3% (e.g., 5%, 10%), whereas the receiving resonator 704 can have an energy transfer efficiency ηo<η1, when the operating frequency does not differ from the at least one of the resonant frequencies by more than 3% (e.g., 5%, 10%). In the disclosed techniques, the spatial distribution of the resonators (e.g., source, receiver, and/or repeater resonators) can be set or adjusted to achieve the features discussed in this specification.

### Example 2

When one or more repeater resonators 706 are arranged adjacent to a source resonator 702, different locations can have maximum energy transfer efficiencies at different operating frequencies of a power source 710. As such, the operating frequency can be adjusted to increase the energy transfer efficiency of a receiver resonator 704 at a fixed location. For example, difference between the operating frequency and the resonant frequencies of the resonators (e.g., source, receiver, repeater resonators) can increase, while the energy transfer efficiency of the receiving resonator 704 increases. Alternatively, the operating frequency can be fixed and the receiver resonator 704 can be repositioned to a location with higher energy transfer efficiency.

FIG. 17a shows an example arrangement of an energy transfer scheme 1700, where multiple receiver resonators 704 (devices 1, 2, 3 and 4) are located at their respective locations. FIG. 17b shows plots 1710, 1712, 1714 and 1716 which presents the normalized energy transfer efficiency for devices 1, 2, 3 and 4, respectively. The x-axis corresponds to the operating frequency of a power source 710 (not shown), which provides energy to a source resonator 702, normalized by the source resonant frequency fₛ. Such plots may be referred as “energy transfer efficiency spectra.” The operating frequency for maximum energy transfer efficiency differs for device 1 and 2, as seen by comparing plots 1710 and 1712. In this example, energy transfer efficiency is maximum at fₒ=fₛ for device 1, and at fₒ=0.85 fₛ for device 2. Plots 1710 and 1716 are identical because of the symmetric arrangement of devices 1 and 4. Likewise, plots 1712 and 1714 are identical because of the symmetric arrangement of devices 2 and 3.

Plot 1720 shows the overall efficiency, which is the summation of plots 1710-1716. In this example, the maximum overall efficiency occurs at fₒ=fₛ. Plots 1722 and 1724 show the impedance spectra (real and imaginary spectra, respectively) of source resonator 702. In this specification, “impedance spectra” refers to the impedance of the specific component in the energy transfer arrangement as a function of frequency.

FIG. 18a shows an example arrangement of an energy transfer scheme 1800, where multiple receiver resonators 704 (devices 1, 2, 3 and 4) are located at their respective locations. FIG. 18b shows plots 1810, 1812, 1814 and 1816 which presents the energy transfer efficiency spectra for devices 1, 2, 3 and 4, respectively. As shown in plots 1810-1816, devices 1-4 each have their own operating frequency where the energy transfer efficiency is maximum. None of these plots 1810-1816 are identical to each other because the none of the positions of devices 1-4 are symmetric with respect to a source resonator 702.

Plot 1820 shows the overall efficiency, which is the summation of plots 1810-1816. In this example, the maximum overall efficiency occurs at fₒ=fₛ. Plots 1822 and 1824 show the impedance spectra (real and imaginary spectra, respectively) of source resonator 702.

The overall transfer efficiency of scheme 1800 is higher than the overall transfer efficiency of scheme, which may be seen by comparing plots 1720 and 1820. The impedance spectra of plots 1822 and 1824 show broader peaks or variations than those in the impedance spectra of plots 1722 and 182. The broader features may be due to the higher overall transfer efficiency, because broader features typically indicates that energy is transferred out from the source resonator 702 more efficiently. Accordingly, in some implementations, the impedance spectra of a source resonator 702 can be measured and relied on (based on the width of spectral features such as peaks) to determine the overall transfer efficiency or energy transfer efficiency of individual receiver resonators 704.

FIG. 19a shows an example arrangement of an energy transfer scheme 1900, where multiple receiver resonators 704 (devices 1, 2 and 3) are located at their respective locations.

FIG. 19b shows plots 1910, 1912 and 1914 which presents the energy transfer efficiency spectra for devices 1, 2 and 3, respectively. As shown in plots 1910-1914, devices 1-3 each have their own operating frequency where the energy transfer efficiency is maximum.

Plot 1920 shows the overall efficiency, which is the summation of plots 1910-1914. In this example, the maximum overall efficiency occurs at fₒ=1.1 fₛ. Plots 1822 and 1824 show the impedance spectra (real and imaginary spectra, respectively) of source resonator 702.

Comparing plots 1710 and 1910, it is noted that the energy transfer spectra differs for device 1 for schemes 1700 and 1900 even when located at the same position. Likewise, comparing plots 1814 and 1914, it is noted that the energy transfer spectra differs for device 3 for schemes 1800 and 1900 even when located at the same position. This is because a receiver resonator 704 (e.g., device 2) located at different positions can affect the energy transfer spectra of another receiver resonator 704 (e.g., device 1 or 3.) Accordingly, in some implementations, the operating frequency of power source 710 may be selected based on the arrangement of one or more receiver resonators 704.

In some implementations, the optimum operating frequency (e.g., when transfer efficiency is maximum or near-maximum) of a receiver resonator 706 at a fixed location can be determined by sweeping the operating frequency of a power source 710. For example, measured plots 1710-1716, 1810-1816 and 1910-1714 can be used to determine the optimum operating frequencies for devices 1, 2, 3 and 4.

In some implementations, the optimum location (e.g., when transfer efficiency is maximum or near-maximum) of a receiver resonator 706 at a fixed operating frequency can be determined by scanning the position of the receiver resonator 706. For example, measured 1710-1716, 1810-1816, 1910-1714 along with the locations of devices 1, 2, 3 and 4 presented in schemes 1700-1900 can be used to determine the optimum location for either devices 1, 2, 3 and 4. In some implementations, a position of a source resonator 702 and/or a repeater resonator 706 can be scanned to determine the optimum location for a receiver resonator 706.

The determination of optimum operation frequency or optimum location can be based on measuring the energy transfer response. In this specification, “energy transfer response” may refer to impedance spectra or energy transfer efficiency spectra of a resonator (e.g., source, receiver, repeater resonator.) The “energy transfer response” may also refer to the comparison (e.g., ratio, difference) of energy supplied by a source resonator 702 and the actual energy transferred out from the source resonator 702. For example, the source resonator 702 may be configured to supply a constant power. The amount of power that is not transferred out to a receiver resonator 704 or repeater resonator 706 (e.g., by being reflected back to the source resonator 702) can be measured. The energy transfer response can be considered as a property of the wireless energy transfer.

Methodology of Operation

Active Mode (Optimize Frequency and Location)

The disclosed techniques can be used to actively optimize the wireless energy transfer. For example, any combination of the operation frequency of a power source 710, resonant frequencies, and locations of resonators can be adjusted based on monitoring energy transfer responses.

FIG. 20 shows an example of a process 2000 used to wirelessly transfer energy. In some implementations, the process 2000 can be used in conjunction with the energy transfer scheme 900 to control the energy transfer distribution to one or more receiver resonators 704. For example, the process 2000 can be used to optimize the energy transfer of a receiver resonator 704 at a first location. As another example, the process 2000 can be used to increase energy transfer to a receiver resonator 704 while reduce energy transfer to another receiver resonator 704.

At 2010, a power source 710 sweeps its operating frequency of the energy provided to adjacent resonators. In some implementations, the sweeping range can be equal or larger than the Γ (or bandwidth Δf) of either source, repeater, or receiver resonators in scheme 900. The sweeping range can be up to 0.2 f (e.g., up to 0.4 f, up to 0.6 f, up to 0.8 f, up to 1.0 f) of either the source, repeater, or receiver resonators.

At 2020, a monitor system 730 measures the energy transfer response of any component (e.g., source, receiver, receiver resonators) in scheme 900. For example, the monitor system 730 can measure the ratio or difference of energy supplied by the power source 710 (or source resonator 702) and the actual energy transferred out from the power source 710 (or source resonator 702). As another example, the monitor system 730 can measure the impedance spectra of the source resonator 702. In some implementations, the monitor system 730 can measure the energy transferred in and out from a receiver resonator 704 or a repeater resonator 706.

At 2030, the power source 710 maintains an operating frequency based on the measured energy transfer response at 2020. For example, the operating frequency can be selected to be the frequency (e.g., which may different from the resonant frequency of the source resonator 702) when maximum energy transfer occurs for a specific receiver resonator 704 positioned at a specific location.

At 2040, the monitor system 730 measures the energy transfer response of any component (e.g., source, receiver, receiver resonators) in scheme 900, while maintaining the operating frequency selected at 2030. In some implementations, the monitor system 730 measures the energy transfer response in a continuous, periodic, or semi-periodic manner. A change in the energy transfer response may indicate that a resonator has been added or removed to the scheme 900, or positions and/or resonant frequencies of one or more resonators have been altered. Accordingly, the monitor system 730 can provide feedback to the power source 720 to operate 2010 based on the measured energy transfer response to repeat process 2000.

FIG. 21 shows an example of a process 2100 used to wirelessly transfer energy. In some implementations, the process 2100 can be used in conjunction with the energy transfer scheme 900 to control the energy transfer distribution to one or more receiver resonators 704. For example, the process 2100 can be used to optimize the energy transfer of a receiver resonator 704 at a first location. As another example, the process 2100 can be used to increase energy transfer to a receiver resonator 704 while reducing energy transfer to another receiver resonator 704.

At 2110, a power source 710 sweeps its operating frequency of the energy provided to adjacent resonators, similar to 2010.

At 2120, a monitor system 730 measures the energy transfer response of one or more components (e.g., source, receiver, receiver resonators) in scheme 900, similar to 2020.

At 2130, the monitor system 730 identifies one or more optimum operating frequencies for N-number of receiver resonators 704.

At 2140, the monitor system 730 instructs the power source 710 to operate at one more of the identified optimum operating frequencies at 2130. For example, when N=2 (for a first receiver resonator and a second receiver resonator) and two distinct operating frequencies are identified, the power source 710 can provide energy at the two distinct operating frequencies. Alternatively, the power source 710 can provide energy by switching back and forth between the two distinct frequencies at a rate that does not interfere with the operation of load devices coupled to the first receiver resonator or second receiver resonator. In some implementations, at least one of the two distinct frequencies may differ from the resonant frequency of a source resonator 702. One of the two distinct frequencies may be substantially similar (e.g., equal) to the resonant frequency of at least of the resonators (e.g., source, receiver, repeater resonators) in the wireless energy transfer system.

FIG. 22 illustrates examples of operation modes of a power source 710. FIGS. 22a and 22b shows examples where the power source 710 operates by sweeping 2210 between frequencies fₐ and f_{b}. In these examples, the sweeping 2210 can be continuous. Alternatively, the sweeping 2210 can include discrete steps of frequency changes. FIG. 22c shows an example where the power source 710 provides energy at operating frequencies f₁ and f₂. FIG. 22d shows an example where the power source 710 provides energy at a substantially constant operating frequency f₁ and at another sweeping frequency 2220. FIG. 22e shows an example where the power source 710 provides energy by alternating between frequency f₁ and f₂. In this example, the time interval t₂−t₁ can be smaller than the time constant (e.g., time the supplied energy decays) of a loading device 720, which is energized by frequency f₁, to ensure proper function of the loading device 720. FIG. 22f shows an example where the power source 710 provides energy by alternating between frequency f₁ and f₂. In this example, the power source 710 provides energy at both frequencies f₁ and f₂ at t₂. In some implementations, more than one separate power sources 710 can be used to provide multiple operating frequencies.

At 2150, the monitor system 730 measures the energy transfer response of one or more components in scheme 900, while maintaining the operating frequency selected at 2030. Based on the measurement, the monitor system 730 provides feedback to the power source 710, similar to 2040.

FIG. 23 shows an example of a process 2300 used to wirelessly transfer energy. In some implementations, the process 2200 can be used in conjunction with the energy transfer scheme 900.

At 2310, a power source is provides energy at a fixed operation frequency.

At 2320, a monitor system 730 measures the energy transfer response of one or more components (e.g., source, receiver, receiver resonators) in scheme 900, similar to 2020.

At 2330, an adjustment system 740 is used to scan the position of one or more of the repeater, source, and/or receiver resonators. In some implementations, the position of a receiver resonator 704 can be scanned while the monitor system 730 measures the energy transfer response in 2320. Based on the measurement, the optimum position for the receiver resonator 704 can be identified. For example, during the scan, the monitor system 730 can measure the energy transferred out by the power source 710. When the transferred out energy is maximum, it can be determined that the receiver resonator 704 receives maximum energy. The determination can be based on other energy transfer responses such as the impedance spectra of the power source 704. In this case, the sharpness of spectral features in the impedance spectra can be used for the determination.

In some implementations, the adjustment system 740 can adjust the resonant frequency of one or more of the repeater, source, and/or receiver resonators while the monitor system 730 measures the energy transfer response in 2320. Similarly, the optimum resonant frequency of the resonators can be determined based on the measured energy transfer response.

At 2340, the adjustment system 740 fixes the positions of the one or more of the repeater, source, and/or receiver resonators based on the identified locations in 2330. In some implementations, the adjustment system fixes the resonant frequency of the one or more of the repeater, source, and/or receiver resonators based on the identified optimum resonant frequencies in 2330.

At 2350, the power source 710 changes its operating frequency. The change can be initiated by a change in the energy transfer response measured by the monitor system 730. Alternatively, the change may automatically occur in a period manner. After 2350, process 2300 is repeated with the new operating frequency. Alternatively, in some implementations, process 2300 can be repeated without 2350. As a result, an optimum arrangement of the location (or resonant frequencies) of the resonators can be determined.

Calibration Mode (Build Library)

The disclosed techniques can be used to calibrate a wireless energy transfer scheme. A data library including information of the energy transfer efficiency as a function of operating frequency, resonant frequencies of resonators, and/or positions of the resonators can be determined. Based on the data library, parameters such as resonant frequencies or locations of the resonators can be preset or adjusted.

FIG. 24 shows an example of a process 2400 used to wirelessly transfer energy. In some implementations, the process 2400 can be used in conjunction with the energy transfer scheme 900.

At 2410, a power source 710 sweeps its operating frequency while a position of a receiver resonator 704 is fixed.

At 2420, a monitor system 730 measures the energy transfer response of one or more components (e.g., source, receiver, receiver resonators) in scheme 900, similar to 2020.

At 2430, an adjustment system 740 moves the position the receiver resonator 704 to a another position. The power source 710 sweeps its operating frequency while the receiver resonator 704 is fixed at the another position.

At 2440, the monitor system 730 measures the energy transfer response of one or more components (e.g., source, receiver, receiver resonators) in scheme 900, similar to 2020. 2410-2440 can be repeated multiple times before proceeding to 2450.

At 2450, a processor receives the measurements of the energy transfer response from the monitor system 730. The processor analyzes and compiles the measured energy transfer response as a function of positions of the receiver resonator 704. The processor produces a data library including information of the energy transfer efficiency as a function of operating frequency, resonant frequencies of resonators, and/or positions of the resonators. This data library can be used when operating the scheme 900.

FIG. 25 shows an example of a process 2500 used to wirelessly transfer energy. In some implementations, the process 2500 can be used in conjunction with the energy transfer scheme 900.

At 2510, a power source 710 provides energy at a fixed operating frequency.

At 2520, a monitor system 730 measures the energy transfer response of one or more components (e.g., source, receiver, receiver resonators) in scheme 900, while a first receiver resonator is located at a fixed position.

At 2530, an adjustment system 740 moves the position the receiver resonator 704 to another position.

At 2540, the monitor system 730 measures the energy transfer response of one or more components (e.g., source, receiver, receiver resonators) while the receiver resonator 705 is located at the another position. 2530 and 2540 can be repeated multiple times before proceeding to 2550.

At 2550, a processor receives the measurements of the energy transfer response from the monitor system 730. The processor analyzes and compiles the measured energy transfer response as a function of positions of the receiver resonator 704. The processor produces a data library including information of the energy transfer efficiency as a function of operating frequency, resonant frequencies of resonators, and/or positions of the resonators. This data library can be used when operating the scheme 900.

Compromise Mode

The disclosed techniques can be used to operate a wireless energy transfer scheme in a compromised mode. In this specification, “compromised mode” may refer to an operation mode where the energy transfer to one or more receiver resonators are not optimal. This mode of operation may be used when the energy transfer efficiency may be sacrificed to power energy of multiple load devices and/or to reduce the impact of dead and/or blind spots. For example, parameters (e.g., operating frequency, resonant frequency or positions of resonators) of the wireless energy transfer scheme can be preset or adjusted such that the energy transfer efficiencies of a first receiver resonator and a second receiver resonator are both not maximum, but large enough to operate a first load device coupled to the first receiver resonator and a second load device coupled to the second receiver resonator.

In some implementations, a power source 710 can provide energy at an operating frequency fₒ which is different from a first optimum operating frequency f₁ for a first receiver resonator and a second optimum operating frequency f₂ for a second receiver resonator. The operating frequency fₒ can be based on energy transfer responses measured by a monitor system 730. For example, referring back to FIG. 19b, plots 1910 and 1912 show that the optimum operating frequency f₁ for device 1 is about 0.98 and that the optimum operating frequency f₂ for device 2 is about 1.1 for device 2. Accordingly, the operating frequency fₒ can be set as 1.05 such that devices 1 and 2 may receive sufficient energy, if not at their optimum energy transfer efficiencies. As another example, the operating frequency fₒ can be selected such that devices 1 and 2 receive substantially the same power (e.g., within 10%, 5%, 2% of each other.)

Referring back to FIG. 22b, a power source 710 can sweep 2210 its operating frequency. In some implementations, the power source 710 can blindly sweep 2210 its operating frequency such that one or more receiver resonators 706 are provided energy for a finite time. The power source 710 operates in a compromise mode because one or more receiver resonators 704 receive energy only at a finite time during the period of a sweep 2210. In these implementations, the power source 710 does not need to maintain its operating frequency to an optimum frequency of a receiver resonator 704, and the number of required control circuitry is reduced. Accordingly, the cost of the wireless energy transfer scheme can be reduced.

Generally, the operating and/or resonant frequencies can be adjusted to compensate for manufacturing deviations. In some implementations, it is difficult to adjust the operating frequency of a power source 710 or the resonant frequencies of the resonator. In this case, the resonators in the energy transfer scheme can be manufactured with pre-defined resonant frequencies as would have been determined by processes 2000, 2100 or 2300-2500. The resonators may not have substantial tunable capabilities (e.g., tunable range is only about Γ of the resonator.)

Applications

Different applications have different constraints. For example, some applications require the receiver resonators to be fixed (e.g., some lighting devices in a building.) In some applications, the repeater resonators need to be fixed. In these examples, the other type of resonators can be moved to control the energy transfer efficiency as described above. When all or most resonators need to be fixed, the operating frequency of the power source can be adjusted. On the other hand, in some applications, it is difficult to adjust the operating frequency (e.g., the power source is an electric outlet from a building.) In these applications, one or more of the resonators can be moved around.

Under Cabinet Lighting with Repeater Resonators

A repeater resonator 706 can be used to enhance power transfer in lighting applications. FIG. 26 illustrates an example of a wireless power transfer system using a repeater resonator 702 used for a kitchen lighting configuration. Power transfer between a source resonators 702 and a receiver resonator 704 built into a light 7704 may be enhanced or improved, by an additional repeater resonator 706 positioned above or next to the lights 7704 or the receiver resonators 704. The addition of a larger repeater resonator 706 next to the lights may increase the coupling and power transfer efficiency between the source and the lights and may allow the use of smaller, less obtrusive, and more efficient sources or source resonators, or smaller lights, or receiver resonators.

In this example, source resonators 702, receiver resonator 704 and repeater resonator 706 can be manufactured with predefined resonant frequencies as would have been determined by processes 2000, 2100 or 2300-2500. This may obviate the need of sweeping the operating frequency or adjusting resonant frequencies of the resonators.

In some implementations, a repeater resonator 706 can be a capacitively loaded loop wound in a planar, flat, rectangular coil sized to fit inside of a cabinet. The repeater resonator 706 can be integrated into a rigid or flexible pad or housing allowing placement of regular cabinet contents on top of the repeater resonator 706. The repeater resonator 706 can be incorporated in materials typically used to line cabinets such as contact paper, mats, non-skid placemats, and the like. In some implementations, the repeater resonator 706 can be designed to attach to the bottom of the cabinet and may be integrated with an attachment mechanism or attachment points for lights. The lights may not require additional receiver resonators 704 but may directly connect or may be integrated into the repeater resonator 706.

A receiver resonator 704 can be built into the light and designed to couple to the repeater resonator. Each light may be integrated with its own receiver resonator and power and control circuitry described herein. Each light my include appropriate AC to AC, AC to DC, or DC to DC converters and drivers to power and control the light emitting portion of the device. With a repeater resonator 706 above the receiver resonators 704 embedded in the lights, it may be possible to position the lights anywhere under the cabinet with freedom to point and move the light at specific areas or points under the cabinet. The lights with the integrated resonators and device power and control circuitry may be attached to the bottom of the cabinet using adhesives, or any number of known fasteners.

In some implementations, a source resonator 702 can be integrated in a source that is an electrical outlet cover or any type of wall plate. One example of a source for under cabinet lighting is depicted in FIG. 27. The source resonator 702 may be integrated into a cover of an electrical outlet 7802 that may cover and fit around an existing outlet 7806. The power and control circuitry 7808 of the source may be integrated into the cover. The cover may plug-in or connect to one of the outlets allowing the power and control circuitry to be powered directly from the outlet with 120 VAC or 230 VAC, and the like, making the source self-contained and not requiring any additional wiring, plugs, electrical outlets, junction boxes, and the like. The source may be retrofitted by end users by replacing the receptacle cover with the wireless source cover.

The source resonator 702 may be integrated in a source that plugs into an electrical located under the cabinet. The source resonator 7804 may extend out or around the electrical outlet providing an extended volume or box into which the resonator and the power and control circuitry may be integrated. The source resonator 7804 may be designed to replace a complete outlet, where the outlet box or outlet junction box may be used for the power and control circuitry of the source. The cover replacing the outlet may have a similar shape or look as a functional outlet cover but may have a resonator integrated into the perimeter of the cover for transferring wireless power. In some implementations, the cover may be decorative to match the kitchen furnishings. The wireless power circuit may include fault interrupt circuits and other necessary safety, power saving, or regulatory circuits.

In some implementations, a source resonator 702 can include manual or automatic switches or sensors for turning the source on or off and thereby allowing a central place for switching on or off the wirelessly powered lights. The source resonator 702 can be integrated with a timer or light sensor to automatically turn on or off when other lights in the area or turned on or off. For example, the wireless power transfer system may include motion sensors or timers to turn lights on and off according to the detected presence of someone in the room or a certain time of day.

In one example, a 15 cm by 15 cm source resonator 7804 including 10 turns of Litz wire and having a quality factor Q greater than 100 is attached to a wall, 23 cm below a hanging cabinet. One round light with an integrated 7.5 cm diameter resonator having eight turns of Litz wire and having a quality factor greater than 100 is mounted 23 cm above the source resonator on the bottom of the cabinet. A rectangular repeater resonator 706, 29 cm by 86 cm, including 10 turns of Litz wire and having a quality factor greater than 100 is placed inside a cabinet 24 cm above the source. In this example, the repeater resonator 706 is used to enhance the efficiency of power transfer between the wall-mounted source and the under-cabinet-mounted lights. Without the repeater resonator 706, the efficiency of power transfer was less than 5%. With the repeater resonator 706 positioned as described, the efficiency of power transfer can be greater than 50%.

Floor Tiles with Repeater Resonators

FIG. 30 shows an example of a wireless floor system 3000 including a source resonator 702 integrated to a floor tile 3010 and/or attached to a wall. The system also includes floor tiles 3002 with repeater resonators 706 (not all are shown) embedded or attached under the floor tiles 3002. The floor tiles 3002 with repeater resonators 706 arranged on a floor can be used to transfer energy from the source resonator 702 to an area or location on the floor tiles 3002, where load devices 720 such as lamp 3008 (which has a receiver resonator 704 not shown) can be placed on. Accordingly, the load devices 720 can receive energy from the source resonator 702 through the repeater resonators 706. In some implementations, load devices 720 may be placed on top of the floor tiles, below the tiles, or next to the tiles. The repeater resonators 704 may be fixed tuned to a fixed resonant frequency close to the resonant frequency of the source resonator 702. Alternatively, the resonant frequencies may differ.

In some implementations, repeater resonators 706 can be positioned around the lamp 3008 to create a defined area of power (floor tiles 3014, 3016, 3018, 3020, 3022, 3024, 3026, 3028) over which the lamp 3008 can be placed to receive energy from the source resonator 702 via the repeater resonators 706. The defined area over which energy is distributed may be changed by adding additional floor tiles 3002 with attached repeater resonators 706 in proximity to at least one other repeater resonator 706. The floor tiles 3002 may be movable and configurable by the user to change the energy distribution as needed or as the room configuration changes. Except a few floor tiles with source resonators 702 which may be wired to a power source 710, floor tiles 3002 can be completely wireless and may be configured or moved by the user or consumer to adjust the arrangement of wireless energy transfer.

To obtain maximum efficiency of energy transfer or to obtain a specific energy transfer distribution in the system 3000, the operating point of one or more resonators can be adjusted. For example, some applications may use non-uniform energy distribution requiring higher power transfer on one end and lower power transfer on another end of the arrangement of the floor tiles 3002. Such a distribution may be obtained, for example, by slightly detuning the resonant frequencies between the repeater resonators 706 and the source resonator 702.

Other Applications

A repeater resonator 706 can be used to enhance or improve wireless power transfer from a source to one or more resonators built into electronics that may be powered or charged on top of, next to, or inside of tables, desks, shelves, cabinets, beds, television stands, and other furniture, structures, and/or containers. The repeater resonator 706 can be used to generate an energized surface, volume, or area on or next to furniture, structures, and/or containers, without requiring any wired electrical connections to a power source 710. The repeater resonator 706 can be used to improve the coupling and wireless power transfer between a source that may be outside of the furniture, structures, and/or containers, and one or more devices in the vicinity of the furniture, structures, and/or containers.

In the example illustrate in FIG. 28, a repeater resonator 706 is used with a table surface to energize the top of the table for powering or recharging of load devices (e.g., electronic devices) 720 that have integrated or attached receiver resonators 704. The repeater resonator 706 can be used to improve the wireless power transfer from them power source 710 to the receiver resonators 704.

In this example, the power source 710 can be configured such that its operating frequency can be swept and adjusted based on the processes 2000, 2100 or 2300-2500 because the positions of receiver resonators 704 may not be fixed or change over time.

In some implementations, a power source 710 and a source resonator 702 can be built into walls, floors, dividers, ceilings, partitions, wall coverings, floor coverings, and the like. A piece of furniture including a repeater resonator 706 can be energized by positioning the furniture and the repeater resonator 706 close to the wall, floor, ceiling, partition, wall covering, floor covering, and the like that includes the power source 710 and source resonator 702. When close to the source resonator 710, and configured to have substantially the same resonant frequency as the source resonator 710, the repeater resonator 706 can couple to the source resonator 702 via oscillating magnetic fields generated by the power source 710. The oscillating magnetic fields produce oscillating currents in the conductor loops of the repeater resonator 706 generating an oscillating magnetic field, thereby extending, expanding, reorienting, concentrating, or changing the range or direction of the magnetic field generated by the power source 710 and source resonator 706 alone. The furniture including the repeater resonator 706 can be effectively “plugged in” or energized and capable of providing wireless power to devices on top, below, or next to the furniture by placing the furniture next to the wall, floor, ceiling, etc. housing the power source 710 and source resonator 702 without requiring any physical wires or wired electrical connections between the furniture and the power source 710 and source resonator 702. Wireless power from the repeater resonator 706 can be supplied to receiver resonators 704 and load devices 720 in the vicinity of the repeater resonator 706. Power sources 710 can include, but are not limited to, electrical outlets, the electric grid, generators, solar panels, fuel cells, wind turbines, batteries, super-capacitors and the like.

A repeater resonator 706 may enhance the coupling and the efficiency of wireless power transfer to receiver resonators 704 of small characteristic size, non-optimal orientation, and/or large separation from a source resonator.

For example, a receiver resonator 704 designed to be integrated into a mobile device such as a smart phone, with a characteristic size of approximately 5 cm, may be much smaller than a source resonator 702, designed to be mounted on a wall, with a characteristic size of 50 cm, and the separation between these two resonators may be 60 cm or more, or approximately twelve or more characteristic sizes of the receiver resonator, resulting in low power transfer efficiency. However, if a 50 cm×100 cm repeater resonator 706 is integrated into a table, as shown in FIG. 28, the separation between the source resonator 702 and the repeater resonator 706 can be approximately one characteristic size of the source resonator 702, so that the efficiency of power transfer from the source resonator 702 to the repeater resonator 706 may be high. Likewise, the smart phone receiver resonator placed on top of the table or the repeater resonator 706, may have a separation distance of less than one characteristic size of the receiver resonator 706 resulting in high efficiency of power transfer between the repeater resonator and the receiver resonator. While the total transfer efficiency between the source resonator 702 and receiver resonator 706 may take into account both of these coupling mechanisms, from the source resonator 702 to the repeater resonator 706 and from the repeater resonator 706 to the receiver resonator 704, the use of the repeater resonator 706 may provide for improved overall efficiency between the source and receiver resonators.

The repeater resonator 706 can enhance the coupling and the efficiency of wireless power transfer between the source resonator 702 and a receiver resonator 704 when the dipole moments of the source resonator 702 and receiver resonators 704 are not aligned or are positioned in non-favorable or non-optimal orientations. In the example shown in FIG. 28, a capacitively loaded loop source resonator 702 is integrated into the wall with a dipole moment that is normal to the plane of the wall. Flat devices, such as mobile handsets, computers, and the like, that normally rest on a flat surface may include receiver resonators 706 with dipole moments that are normal to the plane of the table, such as when the capacitively loaded loop resonators are integrated into one or more of the larger faces of the devices such as the back of a mobile handset or the bottom of a laptop. Such relative orientations may yield coupling and the power transfer efficiencies that are lower than if the dipole moments of the source resonator 702 and receiver resonators 706 were in the same plane, for example. A repeater resonator 706 that has a dipole moment aligned with that of the dipole moment of the receiver resonators 704, as shown in FIG. 28, may increase the overall efficiency of wireless power transfer between the source resonator 702 and receiver resonator 704 because the large size of the repeater resonator 706 may provide for strong coupling even though the dipole moments of the source resonator 702 and repeater resonator 706 are orthogonal, while the orientation of the repeater resonator 706 is favorable for coupling to the receiver resonator 704.

In FIG. 28, the direct power transfer efficiency between a 50 cm×50 cm source resonator 702 mounted on the wall and a smart-phone sized receiver resonator 704 lying on top of the table, and approximately 60 cm away from the center of the source resonator 702, with no repeater resonator 706 present, was calculated to be approximately 19%. Adding a 50 cm×100 cm repeater resonator 706 as shown, and maintaining the relative position and orientation of the source and receiver resonators improved the coupling efficiency from the source resonator 702 to the receiver resonator 706 to approximately 60%. In this one example, the coupling efficiency from the source resonator 702 to the repeater resonator 706 was approximately 85% and the coupling efficiency from the repeater resonator 706 to the receiver resonator 704 was approximately 70%. The improvement is due both to the size and the orientation of the repeater resonator 706.

In some implementations, the repeater resonator 706 may be attached or configured to attach below the table surface or integrated in the table legs, panels, or structural supports. The repeater resonator 706 may be integrated in table shelves, drawers, leaves, supports, a mat, pad, cloth, potholder, and the like, that can be placed on top of a table surface. The repeater resonator 706 may be integrated into items such as bowls, lamps, dishes, picture frames, books, tchotchkes, candle sticks, hot plates, flower arrangements, baskets, or built into chairs, couches, bookshelves, carts, lamps, rugs, carpets, mats, throws, picture frames, desks, counters, closets, doors, windows, stands, islands, cabinets, hutches, fans, shades, shutters, curtains, footstools, drinking glasses, cup mats and the like.

The repeater resonator 706 may have an optional power cable or connector allowing connection to a power source such as an electrical outlet providing an energy source for the amplifiers of the power and control circuits for driving the repeater resonator turning it into a source if, for example, a source resonator is not functioning or is not in the vicinity of the furniture. The repeater resonator 706 may have a third mode of operation in which it may also act as a receiver resonator 704 providing a connection or a plug for connecting electrical or electronic devices to receive DC or AC power captured by the repeater resonator 706. The modes be selected by the user or may be automatically selected by the power and control circuitry of the repeater resonator 796 based on the availability of a source magnetic field, electrical power connection, or a device connection.

The repeater resonator 706 may be designed to operate with any number of source resonators 702 that are integrated into walls, floors, other objects or structures. The repeater resonators may be configured to operate with sources that are retrofitted, hung, or suspended permanently or temporarily from walls, furniture, ceilings and the like.

In some implementations, a repeater resonator 706 may be integrated into a television or a media stand or a cabinet such that when the cabinet or stand is placed close to a source the repeater resonator is able to transfer enough energy to power or recharge electronic devices on the stand or cabinet such as a television, movie players, remote controls, speakers, and the like. Thee repeater resonator 706 may be integrated into a bucket or chest that can be used to store electronics, electronic toys, remote controls, game controllers, and the like. When the chest or bucket is positioned close to a source resonator 702 the repeater resonator 706 may enhance power transfer from the source to the devices inside the chest or bucket with built in receiver resonators to allow recharging of the batteries.

FIG. 29 illustrates an example where a repeater resonator 706 may be used in three different modes of operation depending on the usage and state of the power sources and consumers in the arrangement. FIG. 29 shows a handbag 8602 that is depicted as transparent to show internal components. In this example, there may be a separate bag, satchel, pocket, or compartment 8606 inside the bag 8602 that may be used for storage or carrying of electronic devices 8610 such as cell-phones, MP3 players, cameras, computers, e-readers, iPads, netbooks, and the like. The compartment may be fitted with a resonator 102 that may be operated in at least three modes of operation. In one mode, the resonator 102 may be coupled to power and control circuitry that may include rechargeable or replaceable batteries or battery packs or other types of portable power supplies 8604 and may operate as a wireless power source for wirelessly recharging or powering the electronic devices located in the handbag 8602 or the handbag compartment 8606. In this configuration and setting, the bag and the compartment may be used as a portable, wireless recharging or power station for electronics.

The resonator 102 may also be used as a repeater resonator 706 extending the wireless power transfer from an external source to improve coupling and wireless power transfer efficiency between the external source and source resonator (not shown) and the receiver resonators 704 of the load device 720 inside the bag or the compartment. The repeater resonator 706 may be larger than the receiver resonators inside the bag or the compartment and may have improved coupling to the source.

In another mode, the resonator 102 may be used as a repeater resonator 706 that both supplies power to electronic devices and to a portable power supply used in a wireless power source. When positioned close to an external source or source resonator 702 the captured wireless energy may be used by a repeater resonator 706 to charge the battery 8604 or to recharge the portable energy source of the compartment 8606 allowing its future use as a source resonator. The whole bag with the devices may be placed near a source resonator allowing both recharging of the compartment battery 8604 and the batteries of the devices 8610 inside the compartment 8606 or the bag 8602.

The resonator 102 may include switches that couple the power and control circuitry into and out of the resonator circuit so that the resonator 102 may be configured only as a source resonator 702, only as a repeater resonator 706, or simultaneously or intermittently as any combination of a source, receiver and repeater resonator. An exemplary block diagram of a circuit configuration capable of controlling and switching a resonator between the three modes of operation is shown in FIG. 30. In this configuration a capacitively loaded conducting loop 8608 is coupled to a tuning network 8728 to form a resonator. The tuning network 8728 may be used to set, configure, or modify the resonant frequency, impedance, resistance, and the like of the resonator. The resonator 102 may be coupled to a switching element 8702, with any number of solid state switches, relays, and the like, that may couple or connect the resonator to either one of at least two circuitry branches, a device circuit branch 8704 or a source circuit branch 8706, or may be used to disconnect from any of the at least two circuit branches during an inactive state or for certain repeater modes of operation. A device circuit branch 8704 may be used when the resonator 102 is operating in a repeater or device mode. A device circuit branch 8704 may convert electrical energy of the resonator 102 to specific DC or AC voltages required by a device, load, battery, and the like and may include an impedance matching network 8708, a rectifier 8710, DC to DC or DC to AC converters 8710, and any devices, loads, or batteries requiring power 8714. A device circuit branch may be active during a device mode of operation and/or during a repeater mode of operation. During a repeater mode of operation, a device circuit branch may be configured to drain some power from the resonator 102 to power or charge a load while the resonator is repeating the oscillating magnetic fields from an external source to another resonator.

A source circuit branch 8706 may be used during repeater and/or source mode of operation of the resonator 102. A source circuit branch 8706 may provide oscillating electrical energy to drive the resonator 102 to generate oscillating magnetic fields that may be used to wirelessly transfer power to other resonators. A source circuit branch may include a power source 8722, which may be the same energy storage device such as a battery that is charged during a device mode operation of the resonator. A source circuit branch may include DC to AC or AC to AC converters 8720 to convert the voltages of a power source to produce oscillating voltages that may be used to drive the resonator 102 through an impedance matching network 8716. A source circuit branch may be active during a source mode of operation and/or during a repeater mode of operation of the resonator allowing wireless power transfer from the power source 8722 to other resonators. During a repeater mode of operation, a source circuit branch may be used to amplify or supplement power to the resonator. During a repeater mode of operation, the external magnetic field may be too weak to allow the repeater resonator 102 to transfer or repeat a strong enough field to power or charge a device. The power from the power source 8722 may be used to supplement the oscillating voltages induced in the resonator 8608 from the external magnetic field to generate a stronger oscillating magnetic field that may be sufficient to power or charge other devices.

In some instances, both the device and source circuit branches may be disconnected from the resonator 102. During a repeater mode of operation the resonator may be tuned to an appropriate fixed frequency and impedance and may operate in a passive manner. In other words, the component values in the capacitively loaded conducting loop and tuning network are not actively controlled. A device circuit branch may require activation and connection during a repeater mode of operation to power control and measurement circuitry used to monitor, configure, and tune the resonator 102.

In some implementations, the power and control circuitry of a resonator 102 enabled to operate in multiple modes may include a processor 8726 and measurement circuitry, such as analog to digital converters and the like, in any of the components or sub-blocks of the circuitry, to monitor the operating characteristics of the resonator and circuitry. The operating characteristics of the resonator 102 may be interpreted and processed by the processor to tune or control parameters of the circuits or to switch between modes of operation. Voltage, current, and power sensors in the resonator, for example, may be used to determine if the resonator 102 is within a range of an external magnetic field, or if a device is present, to determine which mode of operation and which circuit branch to activate.

It is to be understood that the exemplary embodiments described and shown having a repeater resonator 102 were limited to a single repeater resonator in the discussions to simplify the descriptions. All the examples may be extended to having multiple devices or repeater resonators with different active modes of operation.

Computer System

The features of the processor can be implemented in digital electronic circuitry, or in computer hardware, firmware, or in combinations of these. The features can be implemented in a computer program product tangibly embodied in an information carrier, e.g., in a machine-readable storage device, for execution by a programmable processor; and features can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program includes a set of instructions that can be used, directly or indirectly, in a computer to perform a certain activity or bring about a certain result. computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Computers include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). To provide for interaction with a user, the features can be implemented on a computer having a display device such as a CRT (cathode ray tube), LCD (liquid crystal display) monitor, e-Ink display or another type of display for displaying information to the user and a keyboard and a pointing device such as a mouse or a trackball by which the user can provide input to the computer.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A wireless power system comprising:
a power source;
a source resonator configured to receive power from the power source, wherein the source resonator has a resonant frequency fₛ=ωₛ/2π, an intrinsic loss rate Γₛ, and is capable of storing electromagnetic energy with an intrinsic quality factor Qₛ=ωₛ/(2Γₛ);
a receiver resonator configured to provide power to a load, wherein the receiver resonator has a resonant frequency f_{rc}=ω_{rc}/2π, an intrinsic loss rate Γ_{rc}, and is capable of storing electromagnetic energy with an intrinsic quality factor Q_{rc}=ω_{rc}/(2Γ_{rc}); and
at least one repeater resonator configured to couple power wirelessly from the source resonator to the receiver resonator, wherein the at least one repeater resonator has a resonant frequency fᵣ₁=ωᵣ₁/2π, an intrinsic loss rate Γᵣ₁, and is capable of storing electromagnetic energy with an intrinsic quality factor Qᵣ₁=ωᵣ₁/(2Γᵣ₁), and
wherein the power source is configured to provide power to the source resonator at a first frequency f₁ different from at least one of the resonant frequencies.

2. The system of claim 1, wherein the first frequency f₁ differs from at least one of the resonant frequencies by more than 3%.

3. The system of claim 1, wherein the resonators are spatially distributed, and wherein the spatial distribution of the resonators causes the receiving resonator to receive power from the source resonator through the at least one repeater resonator with an energy transfer efficiency η₁ larger than 30% and wherein η₁ varies by less than 5% when f₁ varies by less than 5%.

4. The system of claim 1, wherein at least one of the intrinsic quality factors is greater than 100.

5. The system of claim 1, wherein at least one of the resonators comprises a capacitively loaded conducting wire loop.

6. The system of claim 1, wherein the resonators are spatially distributed, and wherein the spatial distribution of the resonators causes the receiving resonator to receive power from the source resonator through the at least one repeater resonator with an energy transfer efficiency η₁, when the power source provides power to the source resonator at a frequency that differs from at least one of the resonant frequencies by more than 3%, and with an energy efficiency ηₒ<η₁, when the power source provides power to the source resonator at a frequency that does not differ from the at least one of the resonant frequencies by more than 3%.

7. The system of claim 1, wherein during operation the power source is configured to vary the frequency of the power provided to the source resonator.

8. The system of claim 7, wherein during operation the power source is configured to adjust the frequency of the power provided to the source resonator to at least one other frequency f₀ within a range of frequencies including the first frequency f₁.

9. The system of claim 8, wherein the frequency f₀ is equal to the resonant frequency of at least one of the resonators.

10. The system of claim 8, wherein the frequency f₀ differs from the resonant frequency of at least one of the resonators by at least 5%.

11. The system of claim 7, wherein the power source is configured to vary the frequency of the power provided to the source resonator as at least one of the resonators moves relative to another one of the resonators.

12. The system of claim 11, wherein during operation the power source is configured to is configured to provide power to the source resonator at the frequencies f₁ and f₀ at the same time.

13. The system of claim 1, wherein the first frequency f₁ differs from the resonant frequency of at least one of the resonators by an amount greater than the intrinsic loss rate for the at least one resonator.

14. A wireless power method comprising:
providing power from a power source to a source resonator; wherein the source resonator has a resonant frequency fₛ=ωₛ/2π, an intrinsic loss rate Γₛ, and is capable of storing electromagnetic energy with an intrinsic quality factor Qₛ=ωₛ/(2Γₛ);
wirelessly transferring power from the source resonator to a receiver resonator through at least one repeater resonator, wherein the receiver resonator has a resonant frequency f_{rc}ω_{rc}/2π, an intrinsic loss rate Γ_{rc}, and is capable of storing electromagnetic energy with an intrinsic quality factor Q_{rc}=ω_{rc}/(2Γ_{rc}) and the at least one repeater resonator has a resonant frequency fᵣ₁=ωᵣ₁/2π, an intrinsic loss rate Γᵣ₁, and is capable of storing electromagnetic energy with an intrinsic quality factor Qᵣ₁=ωᵣ₁/(2Γᵣ₁); and
providing power from the receiver resonator to a load,
wherein the power source provides power to the source resonator at a first frequency f₁ different from at least one of the resonant frequencies.

15. The method of claim 14, the method comprising:
providing energy from the power source to the source resonator at an operating frequency fₒ;
wirelessly transferring energy from the source resonator to one or more receiving resonators through the at least one repeater resonator at the operating frequency fₒ; and
adjusting the operating frequency fₒ to include at least the first frequency f₁ different from at least one of the resonant frequencies corresponding to the resonators to control the energy transfer distribution to the one or more receiving resonators.

16. The method of claim 14, the method comprising:
providing energy from the power source to the source resonator at an operating frequency fₒ;
wirelessly transferring energy from the source resonator to one or more receiving resonators through the at least one repeater resonator at the operating frequency fₒ; and
adjusting the operating frequency fₒ to include at least the first frequency f₁ different from the resonant frequency fₛ of the source resonator.

17. The method of claim 16, further comprising measuring a property of the wireless energy transfer as the operating frequency is adjusted to determine an operating frequency fₒ that improves the wireless energy transfer relative to that for an operating frequency fₒ equal to the resonant frequency fₛ for the source resonator.

18. The method of claim 17, further comprising adjusting a position of one or more of the resonators.

19. The method of claim 18, further comprising measuring a property of the wireless energy transfer as a function of the adjusted operating frequency and the adjusted position of the one or more resonators.

20. The method of claim 17, wherein the measured property of the wireless energy transfer is an energy output from the source resonator or an energy input to the one or more receiving resonators.

21. The method of claim 17, wherein the measured property of the wireless energy transfer is an efficiency of the wireless energy transfer to the one or more receiving resonators.

22. The method of claim 17, wherein the measured property of the wireless energy transfer is an impedance spectrum of one or more of the resonators.

23. A method for configuring a wireless power system, the method comprising:
providing a power source to provide power to a source resonator at an operating frequency fₒ;
positioning one or more receiver resonators, each coupled to a load, at respective desired positions;
positioning at least one repeater resonator to wirelessly transfer energy from the source resonator to one or more receiving resonators through the at least one repeater resonator; and
adjusting the operating frequency fₒ and/or the position of at least one of the repeater resonators to improve the wireless energy transfer to the one or more receiver resonators, wherein the operating frequency fₒ is adjusted to include at least a first frequency f₁ different from at least one of the resonant frequencies corresponding to the resonators.

24. The method of claim 23, further comprising measuring a property of the wireless energy transfer as a function of the adjustment to the operating frequency and/or position of the at least one repeater resonator.

25. The method of claim 23, wherein the operating frequency fₒ and the position of at least one of the repeater resonators are adjusted to improve the wireless energy transfer to the one or more receiver resonators.
